(19) United States
(12) Patent Application Publication
(10) Pub. No.: US 2026/0357534 A1
(43) Pub. Date: Nov. 12, 2026

(54) WORK VEHICLE, CONTROL DEVICE, AND METHOD FOR CONTROLLING LOADER

(71) Applicant: Kubota Corporation, Osaka (JP)

(72) Inventor: Keigo KOMARU, Sakai-shi (JP)

(21) Appl. No.: 19/715,331

(22) Filed: Jun. 22, 2026

Related U.S. Application Data
(63) Continuation of application No. PCT/JP2024/038009, filed on Oct. 24, 2024.

(30) Foreign Application Priority Data
Dec. 28, 2023 (JP) 2023-223632

(51) Int. Cl. E02F 3/43; E02F 9/20; E02F 9/24; E02F 9/26

(52) U.S. Cl. CPC E02F 3/431; E02F 9/2004; E02F 9/24; E02F 9/264

(57) ABSTRACT

A work vehicle includes a loader with changeable height positions and attachment angles at a tip thereof, and a controller configured or programmed to include a memory to store values of a first height position and a first angle indicating target height positions and target attachment angles when the work vehicle moves forward, and values of a second height position and a second angle indicating target height positions and target attachment angles when the work vehicle moves in reverse, execute first control to change the height position and attachment angle to the first height position and the first angle in response to a first user operation causing the work vehicle to move forward, and execute second control to change the height position and attachment angle to the second height position and the second angle in response to a second user operation causing the work vehicle to move backward.

### CROSS REFERENCE TO RELATED APPLICATIONS

This application claims the benefit of priority to Japanese Patent Application No. 2023-223632 filed on Dec. 28, 2023 and is a Continuation Application of PCT Application No. PCT/JP2024/038009 filed on Oct. 24, 2024. The entire contents of each application are hereby incorporated herein by reference.

### BACKGROUND OF THE INVENTION

### 1. Field of the Invention

The present disclosure relates to work vehicles, controllers, and methods for controlling a loader.

### 2. Description of the Related Art

Research and development of smart agriculture that uses information and communication technology (ICT) and the Internet of things (IoT), as the next-generation agriculture, is under way. Automated and unmanned operations of agricultural machines such as tractors used in fields have been studied and developed. For example, work vehicles that travel while performing automatic steering, using a positioning system such as a global navigation satellite system (GNSS) that can perform precise positioning, have been put into practice.

A meter panel that displays and notifies an operator of a travel speed, an engine load state, and the state of each portion of a work vehicle is provided in front of the operator's seat of an agricultural work vehicle such as a tractor.

Japanese Laid-Open Patent Publication No. 2012-32209 describes a commonly used meter panel for passenger cars.

### SUMMARY OF THE INVENTION

A meter panel provided in an agricultural machine such as a tractor is required to accurately notify the operator of various kinds of information about the vehicle when the vehicle is traveling or working. In addition, it is necessary to display more kinds of information in order to allow such an agricultural machine to perform various kinds of works outdoors compared to general passenger cars. In the case in which an agricultural machine is used in smart agriculture, even more kinds of information need to be displayed. However, as the amount of information displayed on the meter panel increases, visibility decreases, and therefore, it is more difficult for the operator to obtain necessary information.

Also, an increased demand for such a meter panel and other displays is not only for agricultural machines but also for construction machines that are used in work in construction sites. Agricultural machines and construction machines that can travel are hereinafter collectively referred to as “work vehicles”.

Various implements (work machines) may be connected to the front or rear of a work vehicle for performing desired work. The implements include, for example, loaders such as front loaders. There is a demand for systems that allow various settings related to a loader, or adjustments to the position or angle of the loader, to be performed more easily.

Example embodiments of the present disclosure provides systems and work vehicles capable of solving such a problem.

The present disclosure provides solutions described in the following example embodiments.

### Item 1

A work vehicle including a loader capable of changing a height position and an angle of an attachment at a tip thereof, and a controller configured or programmed to control an operation of the loader, include a memory configured to store respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse, execute first control to change the height position and angle of the attachment to the first height position and the first angle, respectively, in response to a first user operation that causes the work vehicle to move forward, and execute second control to change the height position and angle of the attachment to the second height position and the second angle, respectively, in response to a second user operation that causes the work vehicle to move in reverse.

### Item 2

The work vehicle of Item 1, further including a switch to switch between a first mode in which the first control and the second control are enabled and a second mode in which the first control and the second control are disabled, wherein the controller is configured or programmed to switch between the first mode and the second mode in response to an operation of the switch by a user, and in the first mode, execute the first control in response to the first user operation and execute the second control in response to the second user operation.

### Item 3

The work vehicle of Item 2, wherein the memory is configured to store respective set values of a third height position and a third angle respectively indicating target height positions and target angles of the attachment for the second mode, and the controller is configured or programmed to change the height position and angle of the attachment to the third height position and the third angle, respectively, in response to an operation of the switch by a user to switch from the first mode to the second mode.

### Item 4

The work vehicle of any one of Items 1 to 3, further including a sensor to measure a load on the loader, wherein the controller is configured or programmed to execute the first control in response to the first user operation and execute the second control in response to the second user operation only when the load exceeds a threshold value.

### Item 5

The work vehicle of Item 4, wherein the controller is configured or programmed to execute the first control in response to the first user operation and execute the second control in response to the second user operation only when a state in which the load exceeds the threshold value has continued for a predetermined time or more.

### Item 6

The work vehicle of any one of Items 1 to 5, further including a display configured to display a setting screen for setting each of the first height position, the first angle, the second height position, and the second angle.

### Item 7

The work vehicle of Item 6, wherein the display includes a meter panel including a digital display to display the setting screen and one or more analog meters.

### Item 8

The work vehicle of any one of Items 1 to 7, wherein the loader includes an actuator configured to change the height position and angle of the attachment, and the controller is configured or programmed to execute the first control and the second control by controlling the actuator.

### Item 9

A controller for controlling a loader in a work vehicle to which a loader capable of changing a height position and an angle of an attachment at a tip thereof is attached, the controller including a memory configured to store respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse, and a control circuit configured to execute first control to change the height position and angle of the attachment to the first height position and the first angle, respectively, in response to a first user operation that causes the work vehicle to move forward, and execute second control to change the height position and angle of the attachment to the second height position and the second angle, respectively, in response to a second user operation that causes the work vehicle to move in reverse.

### Item 10

A method for controlling a loader executed by a controller in a work vehicle to which a loader capable of changing a height position and an angle of an attachment at a tip thereof is attached, the method including storing in a memory respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse, executing first control to change the height position and angle of the attachment to the first height position and the first angle, respectively, in response to a first user operation that causes the work vehicle to move forward, and executing second control to change the height position and angle of the attachment to the second height position and the second angle, respectively, in response to a second user operation that causes the work vehicle to move in reverse.

According to example embodiments of the present disclosure, information display systems capable of displaying various kinds of information required during work with good visibility, work vehicles including such information display systems, and display methods for displaying images are provided.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1A is a side view schematically illustrating an example work vehicle 200 according to an example embodiment of the present disclosure.

FIG. 1B is a diagram illustrating an example of a group of operation switches and an operation terminal provided inside a cabin of a work vehicle.

FIG. 1C is a side view schematically illustrating another example work vehicle according to an example embodiment of the present disclosure.

FIG. 1D is a front view schematically illustrating a meter panel in a state of being attached behind a steering wheel positioned in front of an operator's seat of a work vehicle, in an example embodiment of the present disclosure.

FIG. 2 is a front view illustrating an example arrangement of main components of the meter panel of this example embodiment of the present disclosure.

FIG. 3 is a perspective view illustrating an example configuration of a wall surface portion of the meter panel of this example embodiment of the present disclosure.

FIG. 4 is a perspective view illustrating an example configuration of a transparent cover of the meter panel of this example embodiment of the present disclosure.

FIG. 5 is a front view illustrating an example arrangement of indicators of the meter panel of this example embodiment of the present disclosure.

FIG. 6 is a front view illustrating an example state in which various kinds of information are displayed on a display of the meter panel of this example embodiment of the present disclosure.

FIG. 7 is a perspective view of an analog meter in the meter panel of this example embodiment of the present disclosure.

FIG. 8 is a front view illustrating a positional relationship between a first analog meter, an arc-shaped indicator, and a facing plate.

FIG. 9 is a front view illustrating an example configuration of an arc-shaped indicator.

FIG. 10 is a front view illustrating a second analog meter and a second arc-shaped indicator.

FIG. 11 is a block diagram schematically illustrating an example configuration of an information display system in an example embodiment of the present disclosure.

FIG. 12 is a block diagram illustrating an example hardware configuration of a controller.

FIG. 13 is a diagram illustrating an example in which a controller is implemented inside a meter panel.

FIG. 14A is a front view schematically illustrating an example in which an arc with the same color as that of light emitted from a light emitting region of an arc-shaped indicator is displayed.

FIG. 14B is a front view schematically illustrating an example in which an arc with the same color as that of light emitted from a light emitting region of an arc-shaped indicator, and another object having an arc with the same color, are displayed.

FIG. 15 is a diagram illustrating an example of a home screen.

FIG. 16 is a diagram schematically illustrating an example of segmentation of a display region.

FIG. 17 is a block diagram illustrating an example of a system for controlling an operation of a loader.

FIG. 18 is a diagram for explaining a height and an angle of an attachment at the tip of a loader.

FIG. 19A is a flowchart illustrating an example of an operation of a controller.

FIG. 19B is a flowchart illustrating an example of an operation of a controller.

FIG. 20 is a diagram illustrating an example of a setting screen for setting three target values of height and angle of an attachment of a loader.

### DETAILED DESCRIPTION OF THE EXAMPLE EMBODIMENTS

Meter panels according to example embodiments of the present disclosure will be described below with reference to the accompanying drawings. It should be noted that like reference signs refer to like elements, components, features, etc., throughout the several views.

The example embodiments described below are exemplified to embody technical ideas of the present invention, and the present invention is not limited to the following. Furthermore, the descriptions of sizes, materials, shapes, relative arrangements, and the like of elements, components, features, etc., are not intended to limit the scope of the present invention thereto but intended to be illustrative. The size and positional relationship of elements, components, features, etc., illustrated in the drawings may be exaggerated to facilitate understanding.

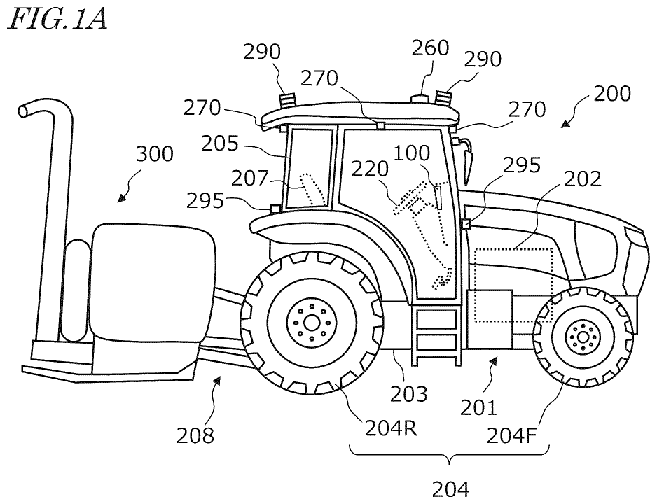

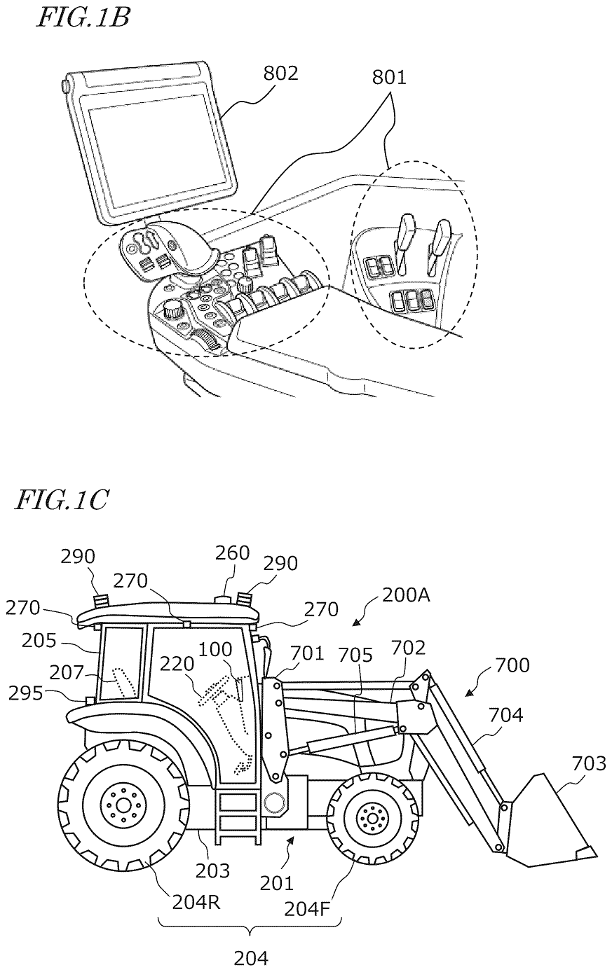

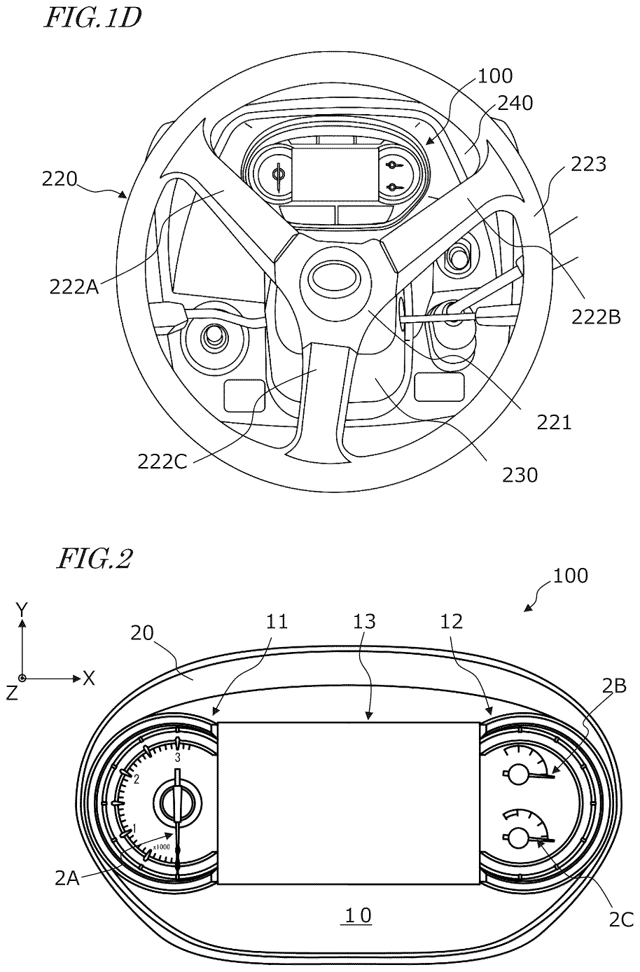

FIG. 1A is a side view schematically illustrating an example work vehicle 200 according to this example embodiment. The illustrated work vehicle 200 is a tractor that tows an implement (replaceable work equipment) 300.

The work vehicle 200 of FIG. 1A includes a vehicle body 201, a prime mover (engine) 202, and a transmission 203. The vehicle body 201 is provided with a travel device including tire-mounted wheels 204, and a cabin 205. The travel device includes four wheels 204, axles to rotate the four wheels, and brakes to slow or stop the axles. The wheels 204 of this example include a pair of front wheels 204F and a pair of rear wheels 204R. One or both of the front wheels 204F and the rear wheels 204R may be replaced by a plurality of wheels to which a continuous track is attached (crawler) instead of a tire-mounted wheel.

In the cabin 205, a meter panel 100 according to an example embodiment of the present disclosure, an operator's seat 207, a steering wheel 220, and switches for operations are provided.

FIG. 1B is a diagram illustrating an example of a group of operation switches 801 and an operation terminal 802 provided inside the cabin 205 of the work vehicle 200.

In the interior of the cabin, a group of operation switches 801 including a plurality of switches operable by the user is arranged. The group of operation switches 801 includes, for example, switches to select the gear stage of the main transmission or sub-transmission, a switch to switch between forward and reverse travel, and switches to operate the implement.

The operation terminal 802 is a terminal for the user to perform operations relating to the travel of the work vehicle and the operation of the implement, and is also referred to as a virtual terminal (VT). The operation terminal 802 may include a touch screen display and/or one or more buttons. The display may be, for example, a liquid crystal or organic light emitting diode (OLED) display.

Referring again to FIG. 1A. The work vehicle 200 of FIG. 1A is provided with a plurality of external sensors to sense surroundings of the work vehicle 200. The external sensors may include various kinds of sensors such as a plurality of cameras 270, a plurality of obstacle sensors 295, and a plurality of LiDAR sensors 290. The cameras 270 may, for example, be provided on the front, rear, left, and right sides of the work vehicle 200. Each camera 270 captures an image of an environment around the work vehicle 200, and generates image data. Images obtained by the cameras 270 may, for example, be transmitted to a terminal device for remote monitoring. The cameras 270 are optionally provided, and the number thereof is not particularly limited. The LiDAR sensor 290 is an example external sensor to output sensor data indicating a distribution of objects present in an environment around the work vehicle 200. In the example of FIG. 1A, two LiDAR sensors 290 are provided at an upper front portion and an upper rear portion of the cabin 205. The LiDAR sensors 290 may be provided at other positions (e.g., a lower portion of a front surface of the vehicle body 201). Each LiDAR sensor 290 repeatedly outputs sensor data indicating distances to and directions of measurement points of objects existing in a surrounding environment, or the three-dimensional coordinate values of the measurement points, while the work vehicle 200 is traveling. The number of LiDAR sensors 290 is not limited to two and may be one or at least three, for example. In the example of FIG. 1A, the plurality of obstacle sensors 295 are provided at a front portion and a rear portion of the cabin 205. The obstacle sensors 295 may be positioned at other positions. The obstacle sensors 295 may include a laser scanner or ultrasonic sonar, for example. The LiDAR sensors 290 and the obstacle sensors 295 may be activated, for example, when the work vehicle 200 travels in an automatic driving mode. The LiDAR sensors 290 and obstacle sensors 295 are optionally provided, and the number of each is not particularly limited. Only one of the LiDAR sensors 290 and obstacle sensors 295 may be provided in the work vehicle 200. In cases where they are not needed, such as when the work vehicle 200 does not have an automatic driving function, the work vehicle 200 need not include the LiDAR sensors 290 and the obstacle sensors 295.

The work vehicle 200 further includes a GNSS unit 260. GNSS collectively refers to satellite-based positioning systems, such as the global positioning system (GPS), the quasi-zenith satellite system (QZSS, for example, Michibiki), GLONASS, Galileo, and BeiDou. The GNSS unit 260 receives satellite signals transmitted from a plurality of GNSS satellites (also referred to as GNSS signals), and performs positioning based on the satellite signals. The GNSS unit 260 is provided at an upper portion of the cabin 205, but the GNSS unit 260 may be provided at other positions.

The engine 202 may, for example, be a diesel engine. An electric motor may be used instead of a diesel engine. The transmission 203 is capable of changing the propelling force and movement speed of the work vehicle 200 by changing gear ratios. The transmission 203 is also capable of allowing the work vehicle 200 to switch between forward movement and rearward movement.

A connecting device 208 is provided at a rear portion of the vehicle body 201. The connecting device 208 includes, for example, a three-point support device (also referred to as a “three-point linkage” or “three-point hitch”), a power take-off (PTO) shaft, a universal joint, and a communication cable. The connecting device 208 can be used to removably connect an implement 300 to the work vehicle 200. The connecting device 208 can change the position or orientation of the implement 300 by raising or lowering the three-point linkage using, for example, a hydraulic device. In addition, power can be transmitted from the work vehicle 200 to the implement 300 through the universal joint. While towing the implement 300, the work vehicle 200 allows the implement 300 to perform predetermined work. A connecting device may also be provided at a front portion of the vehicle body 201. In that case, an implement can be connected in front of the work vehicle 200.

Although the implement 300 of FIG. 1A is, for example, a sprayer for spraying a chemical agent to crops, the implement 300 is not limited to sprayers. For example, any kind of implement 300 such as a mower, seeder, spreader, rake, baler, harvester, plough, harrow, or rotary tiller may be connected to the work vehicle 200 for use.

Thus, the work vehicle 200, which is used in smart agriculture, includes various sensors, and performs various kinds of work together with the implement 300. During such work, it is necessary to give the operator (user or operator) various kinds of information about a travel state and a work state. Therefore, information that should be displayed on the meter panel 100 may significantly vary depending on the kind and phase of work.

It should be noted that the work vehicle 200, such as a tractor, may be configured to travel by manual driving, automatic steering, or automatic driving.

Another example of an implement in the present example embodiment is a loader including a tip to which an attachment is detachably attached. Various attachments suited to the nature of the work are attached to the tip of the loader. The attachments are, for example, grabs such as bale grabs and silage grabs, forks such as roll forks and super pallet forks, or buckets.

FIG. 1C is a side view schematically illustrating an example work vehicle 200A according to this example embodiment. The illustrated work vehicle 200A is a tractor to the front of which a front loader (hereinafter simply referred to as a “loader”) 700 is connected. A bucket 703 is attached as an attachment to the tip of the loader 700. It should be noted that the loader of the present example embodiment is not limited to a front loader, and may be a loader connected to the rear of the vehicle.

The loader 700 illustrated in FIG. 1C includes a support frame 701, a boom 702, a bucket 703, a bucket cylinder 704, and a boom cylinder 705. The loader 700 further includes a microcontroller 710 (see FIG. 11) that controls the operation of the loader. The support frame 701 is fixed to the frame of the vehicle body 201. The boom 702 has an arm-shaped structure and is rotatably supported by the support frame 701 so as to extend forward and upward of the vehicle. The bucket 703 is rotatably supported by an end portion of the boom 702. In the present example embodiment, the fulcrum (or rotational axis) that rotatably supports the boom 702 is referred to as the “boom fulcrum,” and the fulcrum (or rotational axis) that rotatably supports the bucket 703 is referred to as the “bucket fulcrum.”

The loader 700 in the present example embodiment is connected to the vehicle body 201 via a hydraulic coupler and a power connector. The loader 700 includes a hydraulic system having hydraulic valves, and operates under hydraulic control. Specifically, by extending and retracting the boom cylinder 705 hydraulically, the boom 702 can be rotated around the rotational axis located at the boom fulcrum. This makes it possible to raise and lower the loader 700 (or bucket 703). In addition, by extending and retracting the bucket cylinder 704 hydraulically, the bucket 703 can be rotated around the rotational axis located at the bucket fulcrum. This enables scooping and dumping operations of the bucket 703.

The group of operation switches 801 (see FIG. 1B) provided inside the cabin 205 may include an operation lever for performing dump and scoop operations of the bucket 703. An operation joystick for performing dump, scoop, and lift operations of the bucket 703 may be provided inside the cabin 205. In addition, the operation terminal 802 may display a setting screen for the hydraulic control valve of the loader, including a button display for adjusting the flow rate of hydraulic fluid. The operation lever, joystick, and operation terminal 802 are electrically connected to the microcontroller of the loader. The user can perform desired work while operating the boom 702 and bucket 703 by operating the operation lever, joystick, and the setting screen of the operation terminal 802.

FIG. 1D is a front view schematically illustrating the meter panel 100 when the meter panel 100 is attached to a tractor, which is an example work vehicle, in an example embodiment of the present disclosure. In the example illustrated in FIG. 1D, the meter panel 100 is positioned on the front side of the operator's seat of the tractor. Specifically, the meter panel 100 is positioned above a steering column (steering wheel stay) 230 that supports the steering wheel 220 in a manner that allows the steering wheel 220 to rotate, and is fitted into an opening of a meter cover 240. In this example, the steering wheel 220 has a central hub (horn cover) 221, three spokes 222A, 222B, and 222C radially extending from the horn cover 221, and a rim 223 supported by the spokes 222A, 222B, and 222C. The meter panel 100 is provided at a position that allows the operator sitting on the operator's seat to see the meter panel 100. In the example of FIG. 1D, various kinds of information displayed on the meter panel 100 can be seen through an opening between the spokes 222A and 222B.

The meter panel 100 is required to have excellent visibility. In particular, in the case of movable work vehicles capable of performing automatic steering or automatic driving, various kinds of information that are not displayed on general passenger cars need to be displayed during various kinds of agricultural work. For the meter panel 100, having such a feature, the visibility is preferably improved so as to avoid overlooking more important information of various kinds of information. In addition, in the case in which the meter panel 100 is mounted on various work vehicles, it is desirable that the meter panel 100 have a structure that allows easy attachment. As described below, the meter panel 100 of this example embodiment has excellent visibility and is easy to attach.

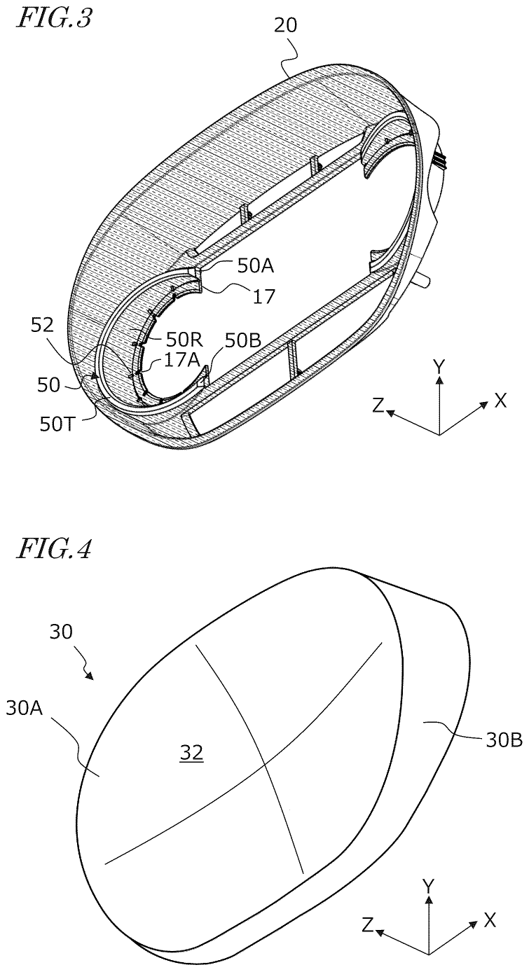

An overall configuration of the meter panel 100 will be described below with reference to FIGS. 2, 3, and 4. FIG. 2 is a front view illustrating an example arrangement of main components of the meter panel 100 of this example embodiment. FIG. 3 is a perspective view illustrating an example configuration of a wall surface portion described below of the meter panel 100. FIG. 4 is a perspective view illustrating an example configuration of a transparent cover described below of the meter panel 100. These drawings illustrate an X-axis, a Y-axis, and a Z-axis that are orthogonal to one another for reference (right-handed coordinate system). In the present description, the positive direction of the Y axis is also referred to as “upward,” and the negative direction thereof is also referred to as “downward.” The positive direction of the X axis is also referred to as “rightward,” and the negative direction thereof is also referred to as “leftward.” The positive direction of the Z axis is also referred to as “forward,” and the negative direction thereof is also referred to as “backward.”

As illustrated in FIG. 2, the meter panel 100 includes a meter portion 10 including a first analog meter 11, a second analog meter 12, and a display (i.e., digital display) 13 provided between the first and second analog meters 11 and 12. In the present description, a portion of the meter portion 10 of FIG. 2 that displays information is also referred to as a display surface side of the meter portion 10.

The first analog meter 11 includes a pointer 2A, and the second analog meter 12 includes pointers 2B and 2C. The pointer 2A is supported in a manner that allows the pointer 2A to rotate around a rotation axis positioned near the center of the first analog meter 11. The pointer 2A indicates the engine speed by the direction in which the tip of the pointer 2A is oriented, for example. Here, “engine speed” may be the number of revolutions of the engine per unit time (for example, one minute). The pointers 2B and 2C are supported in a manner that allows the pointers 2B and 2C to rotate around the respective axes of rotation located at different positions of the second analog meter 12. The pointer 2B indicates the remaining amount of fuel by the direction in which the tip of the pointer 2B is oriented. The pointer 2C indicates the temperature (water temperature) of engine-cooling water by the direction in which the tip of the pointer 2C is oriented, for example. The pointers 2A, 2B, and 2C are driven by a driver (movement) included in the meter portion 10. The driver receives an electrical signal indicating a sensor output such as the engine speed, the remaining amount of fuel, or the water temperature, and converts the electrical signal into mechanical movements for changing the orientations of the pointers 2A, 2B, and 2C. The driver for each pointer 2A, 2B, 2C includes an actuator such as a stepping motor.

The display 13 is a digital meter rather than an analog meter. The display 13 is, for example, an active matrix display, such as a liquid crystal display panel or an organic light emitting diode (OLED). In the following description, as an example, it is assumed that the display 13 is a liquid crystal display (LCD). The display 13 includes a large number of pixels two-dimensionally arranged in a display region, and provides display visible to the human eye by emitting light from the large number of pixels. In this example embodiment, each pixel of the display 13 includes R, G, and B subpixels, and therefore, the display 13 is capable of displaying color images. Unlike analog meters, the display 13 is capable of displaying numerals, letters, graphics, icons, symbols, still images, or moving images having any appropriate sizes at any appropriate positions in the display region. Strictly speaking, numerals, letters, graphics, icons, and symbols are a part of images (still images or moving images) displayed in the display region by the display 13. The display 13 is also capable of apparently displaying an image similar to all or a portion of an analog meter having a pointer. In the case in which the display 13 displays an image of an “analog meter,” a “pointer” in the image can be turned in any appropriate direction as a portion of moving images, by changing images on a frame-by-frame basis. It should be noted that in the case in which the work vehicle is an electric vehicle that is driven by a battery, the display of the engine speed, the remaining amount of fuel, and the water temperature may, for example, be replaced by the display of a motor output, the state of charge of the battery, and the temperature of the battery, respectively.

The “analog meter” displayed by a display such as the display 13 is different from the first analog meter 11 and the second analog meter 12 in that the former is two-dimensional and the latter is three-dimensional. In addition, whereas the shape, color, and size of the pointer and scales of the former analog meter are changeable, it is difficult to change those of the latter. Furthermore, the visibility of the former depends on the contrast of an image, and therefore, is likely to decrease during the daytime, when external light is strong, whereas such a problem with the latter is relatively small. With the above in mind, in this example embodiment, a portion of information displayed in the meter portion 10, particularly information with high importance and requiring high visibility, is displayed using an analog meter having a three-dimensional structure.

An external shape of the meter portion 10 when the meter portion 10 is viewed from the front of the display surface side is a closed loop similar to an ellipse. The external shape of the meter portion 10 is not limited to such an example. The external shape of the meter portion 10 when the meter portion 10 is viewed from the front may have generally a rectangular shape, or a shape that is a combination of a straight line and a curved line.

The meter panel 100 further includes a wall surface portion 20 fixed to the display surface side of the meter portion 10, and a transparent cover 30 opposite the display surface of the meter portion 10.

The wall surface portion 20 surrounds the first analog meter 11, the display 13, and the second analog meter 12 entirely along the peripheral edge of the meter portion 10. The wall surface portion 20 may, for example, be formed of a plastic (synthetic resin). The wall surface portion 20 protrudes vertically (the positive direction of the Z axis) from the display surface of the meter portion 10. The wall surface portion 20 does not necessarily need to be perpendicular to the display surface of the meter portion 10, and may be tilted from the Z axis. In the present disclosure, the distance between the display surface of the meter portion 10 and an end on the front side of the wall surface portion 20 is referred to as a “height” of the wall surface portion 20. In this example embodiment, the height of the wall surface portion 20 is not uniform along the peripheral edge of the meter portion 10, and may vary depending on the position on the peripheral edge.

As illustrated in FIG. 4, the transparent cover 30 includes a front surface section 30A including a concave surface 32, and a side surface section 30B extending from the peripheral edge of the front surface section 30A along the outer side of the wall surface portion 20. The side surface section 30B of the transparent cover 30 can cover the outer side of the wall surface portion 20 along all the periphery thereof. The transparent cover 30 may, for example, be made of a colorless, transparent plastic (e.g., acrylic resin), or glass. In this example embodiment, the front surface section 30A and the side surface section 30B of the transparent cover 30 are integrally formed together.

When the transparent cover 30 is viewed from the direction of the normal to the meter portion 10 with the meter panel 100 attached to the work vehicle, the front surface section 30A of the transparent cover 30 is preferably tilted forward toward the operator. In the case in which the front surface section 30A is tilted forward, when the operator sees the meter portion 10 through the transparent cover 30, the operator's face and the background behind the operator are less likely to be reflected on the transparent cover 30.

Next, an indicator region of the meter portion 10 will be described with reference to FIG. 5. In the example of FIG. 5, the meter portion 10 includes an indicator region 14T provided above the display 13, and indicator regions 14L and 14R provided below the display 13. Various indicators are provided in each of the indicator regions 14T, 14L, and 14R. Each indicator presents predetermined information such as warning when a light emitting device such as a light emitting diode (LED) behind the indicator is on.

It should be noted that in this example embodiment, two indicator regions 14L and 14R that are divided left and right are arranged below the display 13, but one indicator region that integrates the two indicator regions may be arranged.

Visibility of the indicator region 14T, which is positioned above the display 13, is less likely to be obstructed by the spokes 222A, 222B, and 222C of the steering wheel 220, compared to the other indicator regions 14L and 14R. Therefore, it is preferable that indicators for indicating particularly important information (information with a higher warning level) (e.g., indicators for indicating the on/off state of the illumination device, turn signals, and warnings to the operator) be selected from a large number of indicators and arranged in the indicator region 14T. The “warning level” of information displayed by an indicator may, for example, be specified in the manual of the work vehicle. For example, information such as the abnormality or failure of the engine and the on/off state of the headlamp has a higher warning level.

In this example embodiment, each indicator arranged in the indicator region is composed of a light transmission region having a shape that defines a characteristic graphic (including icons and/or letters) and a light emitting device arranged behind the light transmission region. The indicator may be turned on/off by the light emitting device behind the indicator being turned on/off. One or two light emitting devices are arranged behind each indicator, for example.

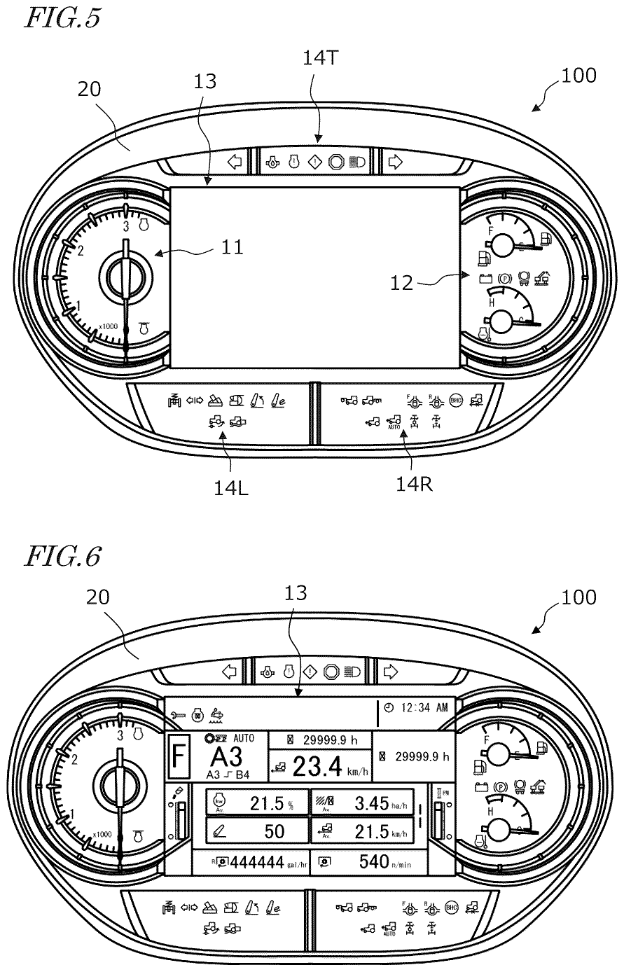

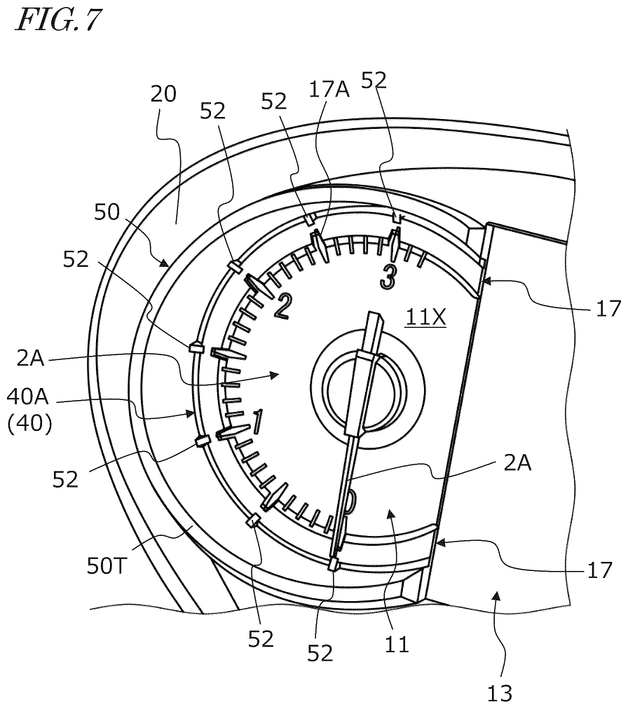

Next, an example display of the display 13 will be described with reference to FIG. 6. In the example of FIG. 6, the display region of the display 13 is divided into several regions as described below. In each region, an “image” showing information such as the gear ratio, vehicle speed, various functional performance information, or hour meter is displayed. The images include various kinds of information represented by letters, numerals, graphics, icons, symbols, and the like. Various kinds of digital images may be indicated by different colors in order to increase the visibility. In particular, when the operator's attention should be attracted, display may be performed in which at least one of the positions, sizes, or colors of letters, numerals, graphics, icons, or symbols are changed and emphasized. When such emphasized display is performed, sound or speech may be emitted from an audio device such as a loudspeaker.

Next, an arc-shaped indicator (C-shaped communication ring) and a facing plate will be described with reference to FIGS. 7 to 9.

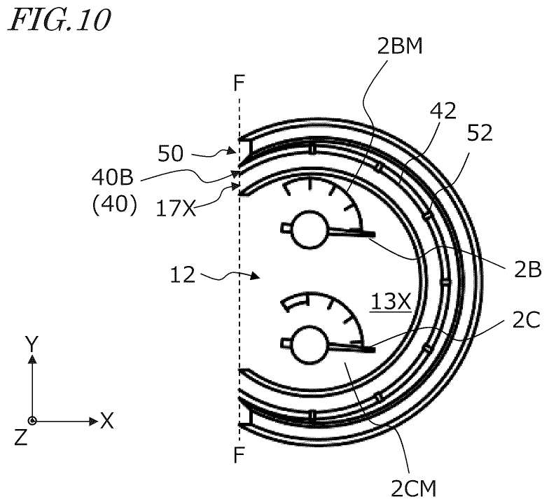

In this example embodiment, the meter panel 100 includes a first arc-shaped indicator (communication ring) 40A arranged around a sweep range 11X of the pointer 2A, and a second arc-shaped indicator 40B (see FIG. 10) arranged around sweep ranges of the pointers 2B and 2C. In the present disclosure, the term “arc” means a portion of a circle (circumference). The circle is not limited to a “perfect circle,” and may include a portion whose curvature is gradually or locally changed like a portion of an ellipse.

The structure of the first arc-shaped indicator 40A and the structure of the second arc-shaped indicator 40B are symmetrical about a vertical line, and therefore, are collectively referred to as arc-shaped indicators 40. The arc-shaped indicators 40 will be described below using the first arc-shaped indicator (communication ring) 40A as an example, for the sake of simplicity.

As illustrated in FIG. 7, the meter panel 100 of this example embodiment includes a facing plate 50 positioned outward of the arc-shaped indicator 40. The facing plate 50 is formed of the same material (plastic) as that for the wall surface portion 20. As illustrated in FIG. 3, the facing plate 50 is integral with the wall surface portion 20. The facing plate 50 is in the shape of roughly an arc as viewed from the front. A height of an upper end 50T of the facing plate 50 varies continuously from an end 50A on the upper side to an end 50B on the lower side, and is greatest at a middle position. The facing plate 50 is a curved wall rising from the meter portion 10.

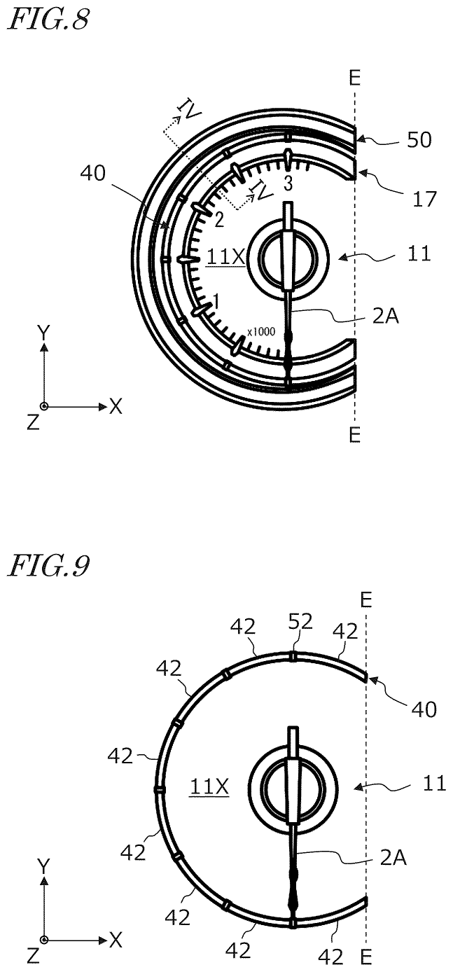

FIG. 8 is a front view illustrating a positional relationship between the first analog meter 11, the arc-shaped indicator 40, and the facing plate 50. FIG. 9 is a front view mainly illustrating an example configuration of the arc-shaped indicator 40. None of the first analog meter 11, the arc-shaped indicator 40, and the facing plate 50 extends rightward (the positive direction of the X axis) beyond a dashed line E-E of FIG. 8. The display 13 is arranged rightward (in the positive direction of the X axis) of the dashed line E-E.

With such a configuration, while the length of the pointer 2A, or the radius of the first analog meter 11, is increased, an increase in the size in the horizontal direction (X-axis direction) of the first analog meter 11 can be reduced. This also holds true for the second analog meter 12. It should be noted that as illustrated in FIG. 1D, when the size in the horizontal direction of the meter portion 10 is increased, the spokes 222A and 222B of the steering wheel 220 are more likely to obstruct seeing of the first and second analog meters 11 and 12. Therefore, it is not preferable to increase the size in the horizontal direction of the meter portion 10. In this example embodiment, the analog meter is contained inside a shape surrounded by the dashed line E-E and an arc rather than a circle. Therefore, even for the meter portion 10, which has a limited size in the horizontal direction, the size in the horizontal direction (X-axis direction) of the display 13 can be increased while the visibility of the first and second analog meters 11 and 12 is increased. In addition, because the first and second analog meters 11 and 12 and the display 13 are separated from each other by a straight line, the display area for analog information and the display area for digital information can be clearly separated from each other, and therefore, the visibility of both analog information and digital information can be improved.

In order to obtain the above effect, it is preferable that the central angle of the “arc” of the arc-shaped indicator 40 (40A), which is arranged, surrounding the first analog meter 11, be greater than 180° and smaller than 270°, for example. If the central angle of the “arc” is at most 180°, the visibility of the first analog meter 11 decreases. If the central angle of the “arc” is at least 270°, for example, the effect of reducing the size in the horizontal direction (X-axis direction) of the first analog meter 11 is not sufficient. This also holds true for the arc-shaped indicator 40 (40B) surrounding the second analog meter 12. In terms of design properties, it is preferable that the left and right arc-shaped indicators 40A and 40B be positioned symmetrically about a vertical line passing through the center of the display 13.

The arc-shaped indicator 40 includes at least one light emitting region 42 between the sweep range 11X of the pointer 2A and the facing plate 50. In the example of FIG. 9, a plurality of light emitting regions 42 are provided. In this example, each light emitting region 42 has a fine curved shape extending along an arc. The plurality of light emitting regions 42 are arranged in a sequence of arcs to provide the arc-shaped indicator 40. In the case in which the number of light emitting regions 42 is one, a single light emitting region 42 has an arc shape.

In the example illustrated in the figure, the first analog meter 11 includes an arc-shaped scale 17 between the arc-shaped indicator 40 and the sweep range 11X of the pointer 2A. The scale 17 has a three-dimensional shape protruding from the display surface (raised scale). The scale 17 is formed of a plastic integrally with the wall surface portion 20 and the facing plate 50. It should be noted that the scale 17 does not necessarily need to have a three-dimensional shape. The scale 17 desirably has a three-dimensional shape in terms of higher visibility.

Although the plurality of light emitting regions 42 included in the arc-shaped indicator 40 may each include a light emitting element (e.g., an LED or OLED), in this example embodiment the plurality of light emitting regions 42 are configured with a plurality of light transmission regions provided on the display surface of the meter portion 10 (i.e., the surface on the front side of the housing of the meter portion 10) and at least one light emitting device arranged behind the plurality of light transmission regions.

The plurality of light emitting devices may include a plurality of LEDs that emit different colors. In this example embodiment, the plurality of light emitting devices include an LED that emits red light, an LED that emits green light, and an LED that emits blue light. By causing these LEDs to selectively emit light, the arc-shaped indicator 40 can exhibit the function of notifying the operator of information using light having various colors. For example, all of the light emitting regions 42 of FIG. 9 can selectively emit red light, green light, and blue light. Alternatively, a light emitting device may be assigned to each of the plurality of light emitting regions 42, and the plurality of light emitting devices may be caused to emit light separately, so that light beams can be sequentially emitted from the plurality of light emitting regions 42.

Next, the raised scale 17 will be described. As illustrated in FIGS. 7 and 8, the raised scale 17 extends in the shape of an arc inside the arc-shaped indicator 40 to form generally a C-shape. As illustrated in FIGS. 3 and 7, the raised scale 17 includes a plurality of notches 17A arranged at predetermined intervals. The notch 17A is a portion of the raised scale 17 whose width is locally reduced. The position of the notch 17A corresponds to the position of a scale that is to be indicated by the tip of the pointer 2A in the first analog meter 11. The presence of the three-dimensional notches 17A facilitates reading of scales by the operator.

As illustrated in FIG. 7, the facing plate 50 includes a plurality of protrusions 52 that protrude toward the sweep range 11X of the pointer 2A. The plurality of protrusions 52 are provided at the positions of the notches of the raised scale 17, or in other words, positions aligned with the scales. Therefore, the notch 17A of the raised scale 17 is recognized as a graphic integrated with the protrusion 52, resulting in an improvement in the visibility of the scale. The plurality of protrusions 52 each extend across between the plurality of light emitting regions 42 of the arc-shaped indicator 40. Therefore, the array of the plurality of light emitting regions 42 also corresponds to the array of the scales.

As can be seen from FIG. 3, the plurality of protrusions 52 serve as a bridge that connects the raised scale 17 to the facing plate 50. The facing plate 50 is connected to the wall surface portion 20. In this example embodiment, the wall surface portion 20, the facing plate 50, and the raised scale 17 are integrally formed of a resin. The plurality of protrusions 52, which extend from the facing plate 50, delimit a boundary portion of the plurality of light emitting regions 42 in the arc-shaped indicator 40.

Next, the second analog meter 12 and the second arc-shaped indicator 40B will be described with reference to FIG. 10. The second arc-shaped indicator 40B and the first arc-shaped indicator 40A are symmetrical about a vertical line, and have substantially the same configuration. A facing plate (right facing plate) 50 is provided outward of the second arc-shaped indicator 40B. The left facing plate 50 and the above facing plate (left facing plate) 50 are symmetrical about a vertical line.

Although an arc-shaped rib 17X corresponding to the raised scale 17 is provided inside the second arc-shaped indicator 40B, no notches are present in the arc-shaped rib 17X. Protrusions (bridges) 52 are equally spaced and arranged between the arc-shaped rib 17X and the right facing plate 50 so as to delimit a plurality of light emitting regions 42 included in the second arc-shaped indicator 40B.

A sweep range 13X of the second pointer 2B and the third pointer 2C is provided in a range surrounded by the second arc-shaped indicator 40B. A rotational angle range 2BM of the second pointer 2B and a rotational angle range 2CM of the third pointer 2C have a similar or congruent outer shape. In the example of FIG. 10, the rotational angle range 2BM of the second pointer 2B and the rotational angle range 2CM of the third pointer 2C are vertically symmetrical, but this is not limited to such an example. The rotational angle range 2BM and the rotational angle range 2CM may have a shape and size such that they overlap each other when one of them is translated in the vertical direction, for example.

With such a configuration, scales can be intuitively read based on the movements of the second pointer 2B and the third pointer 2C, and are less likely to be erroneously read.

An information display system 500 according to an example embodiment of the present disclosure will be described below with reference to FIGS. 11 to 14B. FIG. 11 is a block diagram schematically illustrating an example configuration of the information display system 500 in an example embodiment of the present disclosure. The information display system 500 includes the above meter panel 100, and a controller 400 configured or programmed to control the meter panel 100. The controller 400 may include an electronic control unit (ECU) arranged in the work vehicle. The information display system 500 may further include an audio device such as a buzzer or a speaker.

The information display system 500 is communicably connected via a bus B to an ECU group 610, sensors 620, and a microcontroller 710 of the loader included in the work vehicle. The ECU group 610 may be collectively referred to as a “vehicle controller.” In the present specification, various ECUs included in the work vehicle are referred to as “vehicle ECUs,” and an ECU in the controller 400 included in the information display system 500 is referred to as a “meter ECU” to distinguish between the two. Various vehicle ECUs and the meter ECU can communicate with each other according to a vehicle bus standard such as CAN (controller area network), for example. For example, one vehicle ECU among the ECU group 610 included in the work vehicle receives signals from other vehicle ECUs and sensor data output from each sensor included in the sensors 620, and instructs the meter ECU to display warning messages as described below or to turn on/off/blink indicators according to the state of the work vehicle. The meter ECU receives instructions from the vehicle ECU and causes warning messages to be displayed in the display region or causes indicators to be turned on or off, or to blink.

In FIG. 11, illustration of wiring other than the wiring of the bus B is simplified. However, for example, there may be wiring for directly transmitting signals from one or more sensors included in the sensors 620 included in the work vehicle to the controller 400, or wiring connecting an input device described below and the controller 400. In addition, there is power supply wiring for supplying power from a battery to each of the meter panel 100, the controller 400, the ECU group 610, and the sensors 620 of the work vehicle.

One example of the controller 400 in the present example embodiment is a computing device including at least one processor and at least one memory to store a computer program (code) defining a control process to be executed by the processor. Another example of the controller 400 is a computing device including a hardware accelerator such as an FPGA (Field-Programmable Gate Array), ASSP (Application Specific Standard Product), or ASIC (Application-Specific Integrated Circuit) configured to execute the control process.

A “processor” in the present example embodiment is a hardware electronic circuit such as a CPU (Central Processing Unit), GPU (Graphics Processing Unit), DSP (Digital Signal Processor), ISP (Image Signal Processor), or NPU (Neural Network Processing Unit). A “memory” is a hardware electronic circuit such as a ROM (Read Only Memory) or RAM (Random Access Memory). A portion of the memory may be a storage medium connected to the processor by wiring or a network. These hardware electronic circuits may be implemented by one or more integrated circuits (IC) or large-scale integrated circuits (LSI). Each functional unit or block in an electronic circuit and related components may be individually manufactured as separate integrated circuit chips, or some or all of these functional units or blocks may be combined and manufactured as a single integrated circuit chip.

A program that defines the operation of the processor is designed so that the processor executes one or more functions, operations, steps, or processes in the example embodiments of the present invention.

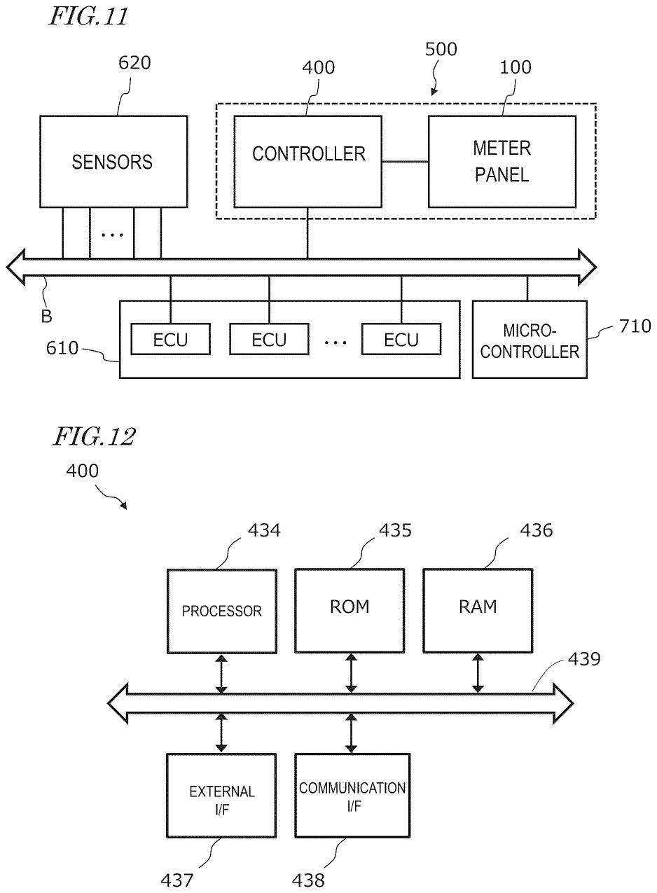

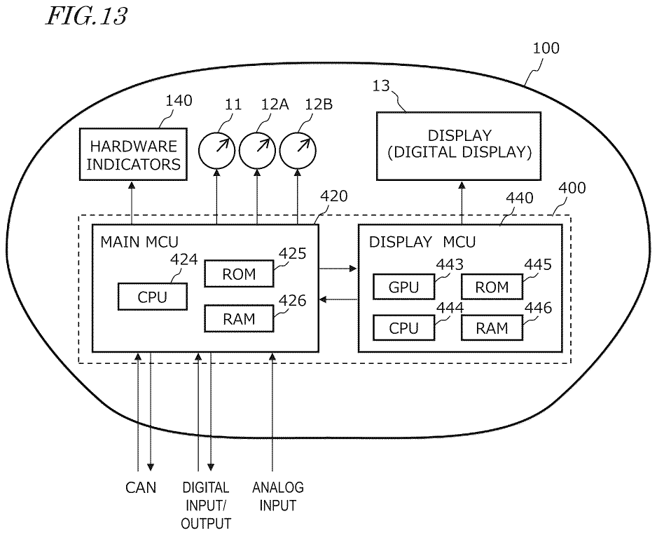

FIG. 12 is a block diagram illustrating an example hardware configuration of the controller 400. The controller 400 includes a processor 434, a ROM 435, a RAM 436, an external I/F 437, and a communication I/F 438. These components are interconnected via a bus 439.

The ROM 435 is, for example, a writable memory (e.g., PROM), a rewritable memory (e.g., flash memory), or a read-only memory. The ROM 435 stores programs that control the operation of the processor. The ROM 435 does not need to be a single recording medium and may be a collection of multiple recording media. A portion of the multiple collections may be removable memory.

The RAM 436 provides a working area for temporarily expanding programs stored in the ROM 435 at boot time. The RAM 436 does not need to be a single recording medium and may be a collection of multiple recording media.

The external I/F 437 is an interface to connect the meter panel 100 to external devices. Examples of the external I/F 437 include a universal serial bus (USB) interface and digital or analog video interfaces.

The communication I/F 438 is an interface to perform communication between the controller 400 and other electronic components or ECUs. For example, the communication I/F 438 can perform wired communication in accordance with various protocols such as CAN or Ethernet®. The communication I/F 438 may perform wireless communication in accordance with Bluetooth® standards and/or Wi-Fi® standards. Both standards include wireless communication standards using frequencies in the 2.4 GHz band.

The controller 400 may further include a storage. The storage may be, for example, a semiconductor memory, a magnetic storage, or an optical storage, or a combination thereof.

The ECU group 610 included in the work vehicle includes, for example, an ECU for speed control, an ECU configured or programmed to perform steering control, and an ECU configured or programmed to perform implement control. When the work vehicle (e.g., tractor) is configured to travel by automatic driving, the ECU group 610 may further include an ECU configured or programmed to perform automatic driving control. The ECU configured or programmed to perform automatic driving control performs calculations and control for realizing automatic driving based on data output from various sensors mounted on the vehicle body.

The sensors 620 may include, for example, a temperature sensor, an illuminance sensor, a fuel sensor, a water temperature sensor, an oil level gauge, an engine rotation sensor, a vehicle speed sensor, a battery voltage sensor, a shuttle sensor, a hand accelerator sensor, an accelerator pedal sensor, a main transmission lever sensor, a sub-transmission lever sensor, a seat belt sensor, a PM sensor, an acceleration sensor, an angular velocity sensor, an inertial measurement unit (IMU), a geomagnetic sensor, an imaging device, a LiDAR sensor, an ultrasonic sensor, an obstacle contact sensor, and a global navigation satellite system (GNSS) receiver.

The controller 400 of the information display system 500 may be an integrated circuit device mounted on a substrate inside the meter panel 100, or may be an external integrated circuit device externally attached to the meter panel 100. Furthermore, some or all of the functions of the controller 400 may be realized by one or more vehicle ECUs. Alternatively, some or all of the functions of the controller 400 may be realized by one or more servers (computers) connected via the communication I/F 438 through a communication network. In this way, one or more vehicle ECUs and/or one or more servers may cooperate with the controller 400 to realize various functions required for the information display system 500. In this case, the vehicle ECU and/or the server function as part of the information display system 500.

FIG. 13 is a block diagram illustrating an example in which the controller 400 is implemented inside the meter panel 100. In this example, the controller 400 includes two microcontroller units (MCUs). The two MCUs are a main MCU 420 and a display MCU 440. The main MCU 420 is a controller that is configured or programmed to control the overall operation of the meter panel 100. The main MCU 420 may also be referred to as a “main controller.” The display MCU 440 is a controller that is configured or programmed to control rendering on the display 13 (i.e., digital display) such as an LCD. The display MCU 440 may also be referred to as a “display controller” or “LCD MCU.”

The main MCU 420 includes components such as a CPU 424, a ROM 425, and a RAM 426, for example. The main MCU 420 controls hardware indicators 140, the first analog meter 11, the second analog meter 12 (in this example embodiment, two analog meters 12A and 12B), and the display MCU 440. The hardware indicators 140 includes the arc-shaped indicator 40 and a plurality of light emitting devices such as LEDs behind the indicator regions 14T, 14L, and 14R illustrated in FIG. 5. The ROM 425 is a non-volatile memory to store software (programs and various data used in processing) to be executed by the CPU 424. The main MCU 420 controls the overall operation of the meter panel 100 by the CPU 424 executing the software. The main MCU 420 may include an interface to communicate with one or more vehicle ECUs connected to the meter panel 100 via an in-vehicle network such as CAN. The main MCU 420 may also include an external interface that enables input and output of digital signals to and from devices directly connected to the meter panel 100. The main MCU 420 may further include an analog interface to which analog signals such as the voltage of the external battery are input.

The display MCU 440 includes components such as a CPU 444, a GPU 443, a ROM 445, and a RAM 446, for example. The ROM 445 is a non-volatile memory to store software to be executed by the CPU 444 and the GPU 443. The display MCU 440 controls rendering on the display 13 (i.e., digital display) by the CPU 444 and GPU 443 executing the software.

In the example illustrated in FIG. 13, the display MCU 440 dedicated to image processing is provided separately from the main MCU 420. This is to achieve relatively high-load rendering such as color camera images and 3D display on the display 13 such as a relatively large (e.g., 10 inches or more) and high-definition LCD. Unlike the present example embodiment, if the display 13 is small or a monochrome liquid crystal display and sophisticated image processing is not required, the display MCU 440 may not be provided, and one controller (i.e., the main MCU 420) may perform all control including rendering.

In the information display system 500 of this example embodiment, the controller 400 is configured or programmed to cause the arc-shaped indicator 40 to display information before causing the display 13 to display various kinds of information when the work vehicle is started. This allows information that the operator should first be aware of to be presented to the operator with higher priority at startup. Such information has information indicating a state (a state classified as abnormality in traveling or working) of the work vehicle. The controller 400 is also configured to change the color of emitted light according to contents of information. For example, the controller 400 may be configured or programmed to emit blue light from the arc-shaped indicator 40 when an abnormality does not arise during starting, and to emit red light indicating an abnormality immediately after starting if a problem is expected to arise during traveling. Examples of a cause for a problem that will arise during traveling include an abnormal voltage of a battery, an abnormal pressure of an engine oil, abnormal heating of an engine, and an abnormality in a brake system. It should be noted that the color of the emitted light is not limited to blue or red, and may be green.

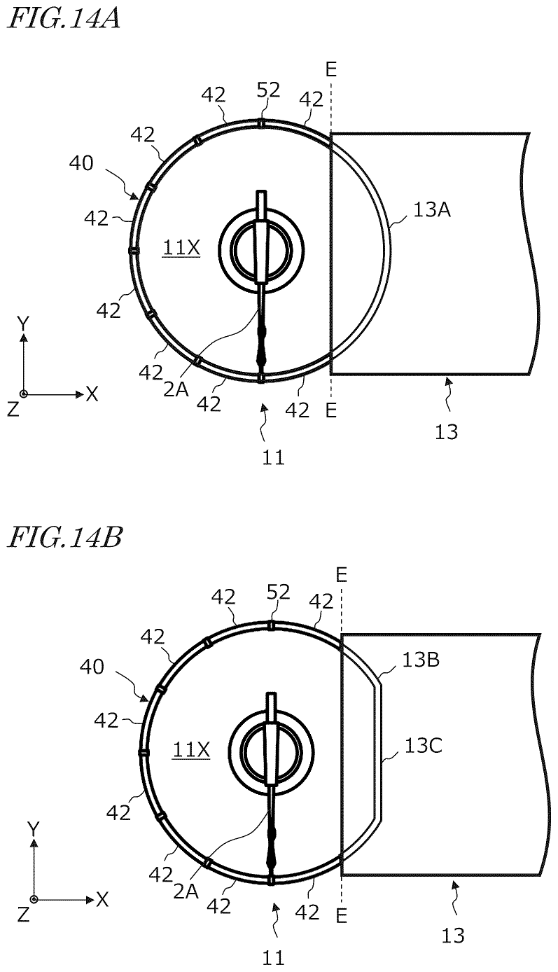

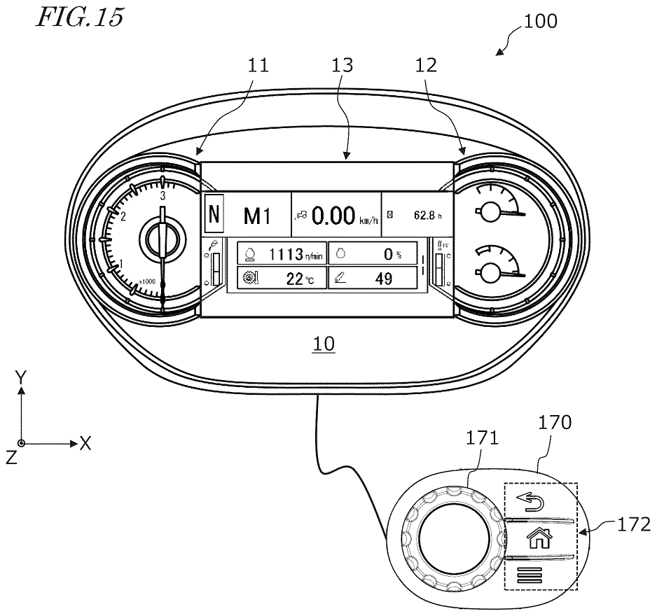

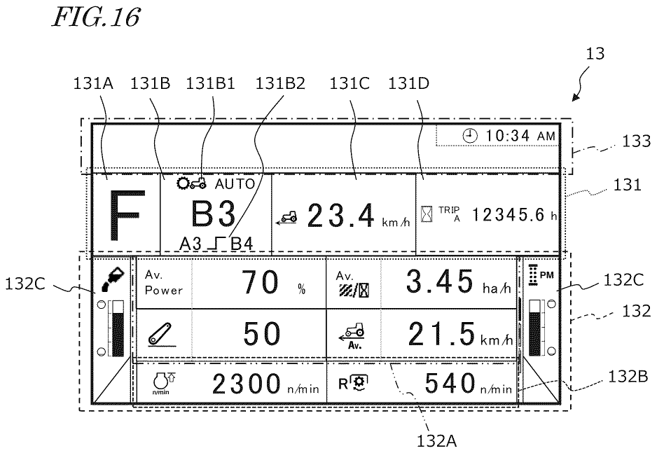

Furthermore, in this example embodiment, the controller 400 is configured or programmed to cause the display 13 to display a curved line-shaped image positioned on an extension of the arc. FIG. 14A is a front view schematically illustrating an example in which an arc 13A having the same color as that of light emitted from the light emitting region 42 of the arc-shaped indicator 40 is displayed. In FIG. 14A, as an example, an arc 13A having the same center as that of the arc of the arc-shaped indicator 40 is displayed. FIG. 14B is a front view schematically illustrating an example in which an arc 13B having the same color as that of light emitted from the light emitting region 42 of the arc-shaped indicator 40, and another object 13C having an arc with the same color, are displayed. In the example of FIG. 14B, the object 13C is a straight line portion. The controller 400 causes the display 13 to display the concentric arc 13B with the arc of the light emitting region 42, and the straight line portion connected to the arc 13B. The straight line portion extends in parallel with a straight line forming the boundary between the first analog meter 11 and the display 14 (corresponding to a dashed line E-E of FIG. 14B). By providing such display, a portion of the circle surrounding the first analog meter 11 that is cut away by the dashed line E-E is seen as a portion of the first analog meter 11 by the operator, and therefore, the operator can feel that the first analog meter 11 is large. In addition, an image that is displayed as if the image were a portion of the first analog meter 11 (hereinafter referred to as a “ring-complement image”) may be partially hidden by information such as numerals or letters displayed on the display 13. Similarly to the shaped object 13C, the portion of the arc 13B may include a straight line shape. By including a straight line shape in the portion displayed on the display 13, a sharp design can be achieved.

The controller 400 can be configured or programmed to cause the display 13 to display various images, which are not limited to the examples of FIGS. 14A and 14B, in association with light emitted from the light emitting region 42 of the arc-shaped indicator 40. The controller 400 can also be configured or programmed to cause the display 13 to display various images in synchronization with the flickering of the light emitting region 42 of the arc-shaped indicator 40. What is conveyed by the display of the arc-shaped indicator 40 to notify the operator can be more easily understood by the operator by emphasizing that display and the display of the display 13 or associating these displays with each other.

After startup of the meter panel 100, a home screen is displayed in the display region of the display 13. FIG. 15 is a diagram illustrating an example of a home screen. Starting from the home screen, the user can perform operations to change the display of content on the display region or select various setting items using an input device described below.

In the example illustrated in FIG. 15, an input device 170 that enables interactive operations by the user is connected to the meter panel 100 via a communication cable. The input device 170 has, for example, a selector switch 171 such as a jog dial and an operation switch 172. The input device 170 may be connected to the meter panel 100 wirelessly or by wire. Any device that accepts user operations can be used as the input device 170. The input device 170 may be, for example, a rotary switch, a slide switch, a push button switch, a touch screen, a joystick, or a combination of two or more thereof.

The display 13 includes a display region in which various images showing information about the work vehicle are displayed. Information about the work vehicle includes, for example, information related to an internal combustion engine (engine), the vehicle body, a PTO shaft, hydraulics/three-point hitch, and electrical equipment provided in the vehicle body. This information is information indicating the internal state of the vehicle system. Information related to the vehicle body includes, for example, information about the direction of travel of the vehicle, clutch, transmission, brakes, headland control, and cruise control. Furthermore, various content including, for example, camera images, radio setting screens, and audio setting screens may be displayed in the display region of the display 13.

Next, segmentation of the display region will be described with reference to FIG. 16. FIG. 16 is a diagram schematically illustrating an example of segmentation of the display region. The display region of the display 13 is divided into multiple blocks. In other words, the display region of the display 13 has multiple regions. The multiple regions in the example illustrated in FIG. 16 include a primary region 131, a sub-region 132, and an LCD indicator region 133. The primary region 131 in FIG. 16 is a region surrounded by a dotted line in the display region of the display 13. The sub-region 132 is a region surrounded by a dashed line in the display region of the display 13. The LCD indicator region 133 is a region surrounded by a dash-dot line in the display region of the display 13. These three regions do not overlap with each other. It should be noted that the dashed lines, dotted lines, and dash-dot lines in FIG. 16 are partially overlapping for clarity.

The primary region 131 is a region to display images in the foreground (or front). The primary region 131 in the example illustrated in FIG. 16 is a rectangular region (or panel-shaped region). However, the external shape of the primary region 131 may be, for example, an ellipse or a figure that is a combination of straight lines and curved lines. A primary image showing more important information (hereinafter referred to as “primary information”) among information about the work vehicle is displayed in the primary region 131. The primary information is information that the user should know with priority, and includes, for example, information indicating the direction of travel of the work vehicle, transmission state, and vehicle speed (hereinafter referred to as “vehicle speed”).

The primary information indicated by the primary image displayed in the primary region 131 in this way is displayed in the foreground of the display region. As illustrated in FIG. 15, the primary image is displayed in front of the ring-complement image. In this way, the primary image can appropriately convey primary information to the user without being hidden by other images or content. Therefore, the visibility of primary information with particularly high importance among various information is improved, and overlooking of primary information is reduced.

In the example illustrated in FIG. 16, the primary region 131 has a belt-shaped configuration extending in the horizontal direction. Multiple types of information about the travel state of the work vehicle are displayed in the primary region 131. The primary region 131 is divided into multiple regions. In the example of FIG. 16, the primary region 131 is divided into a first region 131A, a second region 131B, a third region 131C, and a fourth region 131D arranged horizontally.

The first region 131A positioned at the left end displays the state of the shuttle lever of the work vehicle, that is, the direction of travel. The first region 131A displays, for example, information indicating whether the shuttle lever is in a forward (F), neutral (N), or reverse (R) state.

The second region 131B positioned second from the left displays information about the transmission state, for example, setting of the gear stage of the work vehicle. In the example of FIG. 16, the current settings of the main transmission and sub-transmission are displayed as “B3” symbols in the second region 131B. “B” indicates the setting stage of the sub-transmission, and “3” indicates the setting stage of the main transmission. The second region 131B may display an icon 131B1 indicating that it is in automatic transmission mode and a range 131B2 of gear stages in the automatic transmission mode, as illustrated in FIG. 16.

The third region 131C displays vehicle speed information. The controller 400 switches and displays vehicle speed information in kilometer units or mile units according to, for example, commands from the vehicle ECU.

The fourth region 131D at the right end displays information other than the direction of travel, transmission state, and vehicle speed. In the example of FIG. 16, the fourth region 131D displays the measured value of the hour meter, that is, the operating time of the work vehicle up to now. The fourth region 131D may display other information, not limited to the measured value of the hour meter. For example, various information such as the upper limit setting value of engine speed or the target value of engine speed recorded in memory may be displayed in the fourth region 131D. The controller 400 may be configured or programmed to dynamically change the display of the fourth region 131D according to, for example, commands from the vehicle ECU. The fourth region 131D, together with a region 132B described below, dynamically displays the performance of travel and work of the work vehicle. Therefore, the fourth region 131D is sometimes referred to as a “dynamic performance monitor region.”

The sub-region 132 is positioned below the primary region 131. Various content is displayed in the sub-region 132. The sub-region 132 in the example illustrated in FIG. 16 is a rectangular region and is further divided into three types of regions. The sub-region 132 includes a performance monitor region 132A, a dynamic performance monitor region 132B, and two gauge regions 132C.

The performance monitor region 132A is the largest region among the three regions included in the sub-region 132 and is positioned toward the upper side of the sub-region 132. The performance monitor region 132A is sometimes referred to as the “upper region” in the sub-region 132. The performance monitor region 132A mainly displays one or more items selected by the user (hereinafter referred to as “selected items”) from among various items showing various functional performance information. Examples of items that can be selected by the user include information about engine speed, engine speed upper limit setting value, engine speed memory value, fuel consumption, fuel efficiency, travel distance, load factor, PTO shaft rotation speed, slip rate, diesel particulate filter (DPF) regeneration, and work area.

The screen of selected items may include multiple pages that can be advanced or returned by the user operating the input device. FIG. 16 shows an example of multiple selected items displayed on one page among multiple pages. In the example illustrated in FIG. 16, four selected items are displayed on one page. However, the number of selected items displayed on one page is not limited to four and may be, for example, two, three, or five or more.

The dynamic performance monitor region 132B is positioned toward the lower side of the sub-region 132. The dynamic performance monitor region 132B is sometimes referred to as the “lower region” in the sub-region 132. Various items showing the various functional performance information described above may be displayed in the dynamic performance monitor region 132B. The display of information displayed in the dynamic performance monitor region 132B may be controlled by the controller 400 (e.g., meter ECU) that receives commands from, for example, the vehicle ECU. The controller 400 may be configured or programmed to change the display of the dynamic performance monitor region 132B in response to commands from the vehicle ECU. As illustrated in FIG. 16, for example, two items may be displayed in the dynamic performance monitor region 132B. However, the number of items is not limited to two. Nothing may be displayed in the dynamic performance monitor region 132B as illustrated in FIG. 15.

The gauge regions 132C are positioned on the right and left sides of the sub-region 132. The performance monitor region 132A and the dynamic performance monitor region 132B are positioned between the two gauge regions 132C on the right and left. Gauge images including icons and scales may be displayed in each of the gauge regions 132C on the right and left sides. Examples of gauge images include information about the remaining amount of diesel exhaust fluid (DEF), particulate matter (PM) accumulation, and tire air pressure.

The images displayed in the performance monitor region 132A and the dynamic performance monitor region 132B may be changed according to user operations using the input device. For example, camera images, images for radio or audio settings, images for front loader control, images for cylinder flow control, images for setting operators, images for steering assist control, images for automatic steering control, images for attachment work machine control, or launcher images displaying a list of functional items may be displayed in a region corresponding to the entire performance monitor region 132A and dynamic performance monitor region 132B. By integrating two or more regions and using them as one region in this way, images and content can be displayed relatively large.

The LCD indicator region 133 is positioned above the primary region 131. The LCD indicator region 133 in the example illustrated in FIG. 16 is a rectangular region like the primary region 131 and the sub-region 132. The LCD indicator region 133 functions as a region to display information indicating the state of the work vehicle, warning information, maintenance-related information, and the like. For example, indicators that turn on when a warning state such as brake warning or fuel remaining warning should be issued and turn off when the state is resolved may be displayed in the LCD indicator region 133. As another example, indicators that turn on periodically to prompt the user for maintenance such as DPF regeneration or engine oil change may be displayed in the LCD indicator region 133. As a further example, indicators to request an increase or decrease in engine speed may be displayed in the LCD indicator region 133. In the LCD indicator region 133, no indicators are normally displayed, and a black background is displayed. When a state requiring display of warning or maintenance information arises, the indicator corresponding to that warning or maintenance information turns on. A maximum of, for example, about 10 indicators may be displayed in the LCD indicator region 133. Since indicators can be displayed prominently against a black background, it is possible to make it easier for the operator or user to notice the occurrence of LCD indicators.

The LCD indicator region 133 is positioned below the indicator region 14T illustrated in FIG. 5. The indicators arranged in the indicator region 14T are hardware indicators that are turned on by light emitting devices such as LEDs. In contrast, the indicators displayed in the LCD indicator region 133 are turned on by drawing processing on the LCD. In this specification, hardware indicators using LEDs are referred to as “LED indicators,” and indicators displayed in the LCD indicator region 133 are referred to as “LCD indicators,” and the two may be distinguished.

A popup image including a message for notifying the user of the content of an abnormality or failure when, for example, an abnormality or failure of the engine or electrical equipment is detected, or a message for warning about the internal state of the vehicle system (hereinafter sometimes referred to as a “popup image”) may also be displayed in the sub-region 132 illustrated in FIG. 16. In addition, popup images including messages indicating maintenance information may also be displayed in the sub-region 132.

Next, an example of a system and method for controlling the height position and angle of an attachment attached to the tip of a loader in a configuration in which the loader 700 is attached to the work vehicle 200 as illustrated in FIG. 1C will be described. In the following description, the height position of the attachment means the position of the attachment in the height direction (i.e., the vertical direction), and is also simply referred to as the “height of the attachment”.

The work vehicle 200 illustrated in FIG. 1C includes a loader 700 capable of changing the height position and angle of an attachment (e.g., bucket 703, fork, grab, etc.) at the tip thereof. The work vehicle 200 further includes a controller to control the operation of the loader 700. The controller may include, for example, the microcontroller 710 illustrated in FIG. 11. The controller may be one or more ECUs (vehicle ECUs) included in the ECUs 610. The controller may be a combination of the microcontroller 710 and one or more ECUs (vehicle ECUs) included in the ECUs 610. The controller may further include a controller within the meter panel 100. In this way, the controller does not need to be a single device, and may be a collection of a plurality of devices.

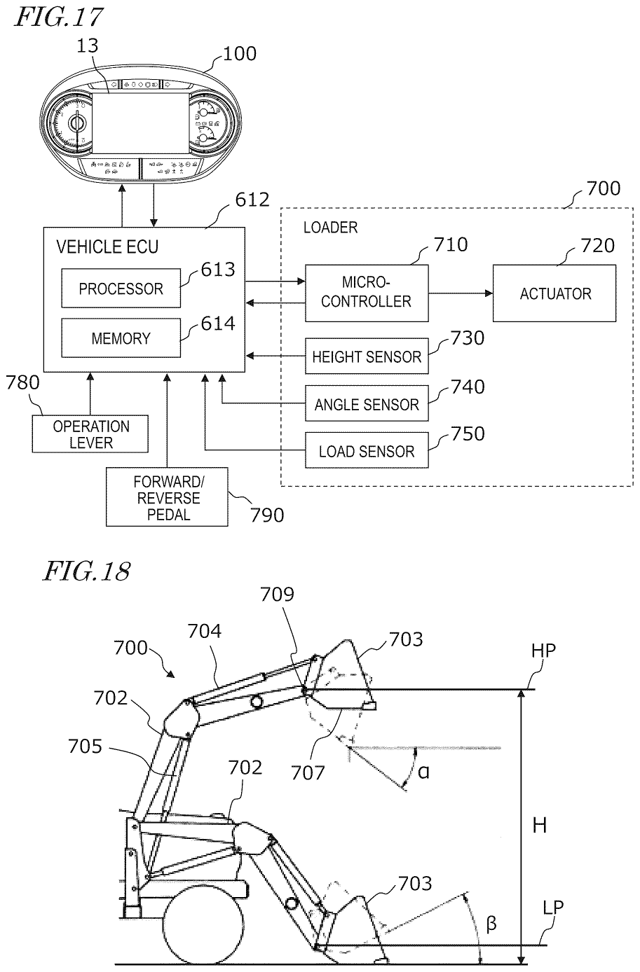

FIG. 17 is a block diagram illustrating an example of a system for controlling the operation of the loader 700. This system includes a vehicle ECU 612, a loader 700, and a meter panel 100. In this example, the loader 700 includes a microcontroller 710 and one or more actuators 720. The loader 700 further includes a height sensor 730 to measure the height of the attachment, an angle sensor 740 to measure the angle of the attachment, and a load sensor 750 to measure the load on the attachment. FIG. 17 also illustrates a loader operation lever 780 for operating the loader 700, and a pedal 790 for moving the work vehicle 200 forward or in reverse. The pedal 790 may be, for example, an HST (Hydro Static Transmission) pedal. The loader operation lever 780 and the pedal 790 are included in the switches 801 illustrated in FIG. 1B.

The actuator 720 includes a mechanism to change the height position and angle of the attachment at the tip of the loader 700. The actuator 720 may be, for example, a hydraulic actuator including the boom cylinder 705 and bucket cylinder 704 illustrated in FIG. 1C and a hydraulic system to extend and retract these cylinders. The actuator 720 may be an electric actuator that drives one or more electric motors to change the height position and angle of the attachment.

The microcontroller 710 is configured or programmed to control the operation of the actuator 720. The microcontroller 710 can communicate with the vehicle ECU 612 via a bus such as a CAN bus. It should be noted that the loader 700 may not include the microcontroller 710. In that case, the vehicle ECU 612 may be configured to directly control the actuator 720.

The vehicle ECU 612 includes one or more processors 613 (control circuits) and one or more memories 614. A computer program executed by the processor 613 is stored in the memory 614. By the processor 613 executing the computer program, the vehicle ECU 612 controls the loader 700 and the meter panel 100.

In the example of FIG. 17, the vehicle ECU 612 issues a command to the microcontroller 710 of the loader 700 to adjust the height and/or angle of the attachment at the tip of the loader 700 to a desired value. In response to this command, the microcontroller 710 drives the actuator 720 to change the height and/or angle of the attachment to the desired value.

In the example of FIG. 17, the vehicle ECU 612 also executes control to cause the display 13 (digital display) of the meter panel 100 to display a setting screen relating to the operation of the loader 700. The meter panel 100 has, for example, the configuration illustrated in FIG. 13. The vehicle ECU 612 can cause the display 13 to display desired information via the display MCU 440 by sending a command to the main MCU 420 in the meter panel 100.

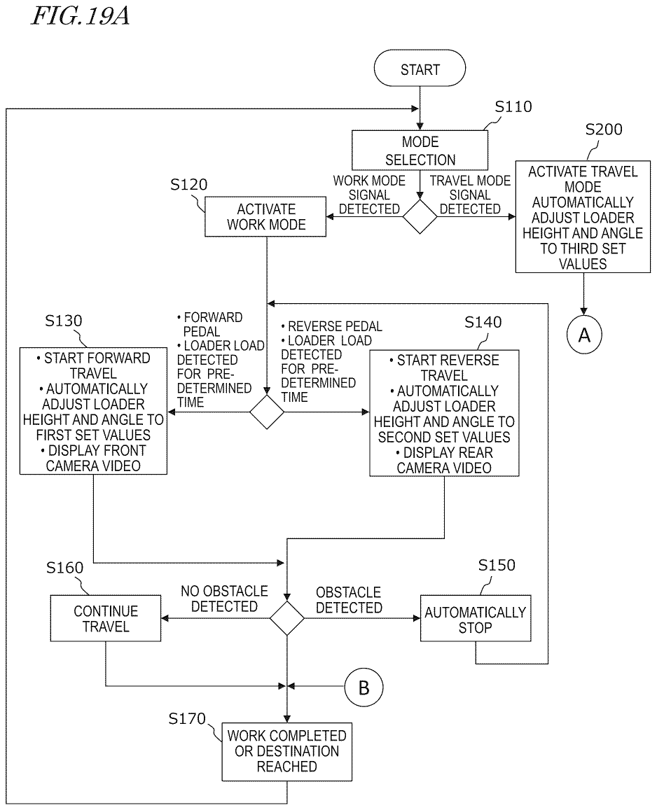

Here, the height and angle of the attachment attached to the tip of the loader 700 will be described with reference to FIG. 18.

FIG. 18 is a diagram for explaining the height and angle of the attachment at the tip of the loader 700. In this example, a bucket 703 is attached as the attachment. As illustrated in FIG. 18, the boom 702 of the loader 700 can be raised and lowered within a lifting range from a lower limit height LP to an upper limit height HP under control by the microcontroller 710. As illustrated in FIG. 18, the distance from the ground to the bucket pivot 709 is defined as the height H of the attachment. When the boom 702 is fully extended, the height H of the attachment matches the upper limit height HP. The angle of the attachment is the angle formed between the ground or horizontal plane and the bottom surface 707 of the attachment. The angle of the attachment when the bottom surface 707 of the attachment is tilted downward relative to the horizontal plane is sometimes referred to as the “dump angle”, and the angle of the attachment when the bottom surface 707 is tilted upward relative to the horizontal plane is sometimes referred to as the “scoop angle”. In FIG. 18, an example of the dump angle is indicated by angle α, and an example of the scoop angle is indicated by angle β. The actuator 720 can change the height of the bucket 703 by extending and retracting the boom cylinder 705, and can change the angle of the bucket 703 by extending and retracting the bucket cylinder 704. This operation is performed by the user's operation using the operation lever 780.

Work using such a loader 700 is mainly classified into three types: “scooping (Ground)”, “transporting (Transport)”, and “dumping (Dump)”. Lever operations are performed several hundred to several thousand times a day, and adjustments to the height and angle of the bucket 703 corresponding to these operations are repeatedly executed. For example, in work for transporting soil and sand, the operations of scooping up soil and sand with the bucket 703 while moving the work vehicle 200 forward, raising the bucket 703 to transport the soil and sand while moving the work vehicle 200 in reverse, and lowering the bucket 703 at a predetermined position (e.g., a truck bed) to drop the soil and sand may be repeatedly executed. For such work, it is necessary to precisely adjust the position of the bucket 703 through fine lever operations. Such lever operations require high skill, and are not easy for workers with low skill levels. In addition, repeatedly performing such lever operations is a heavy burden on the worker, and there is a demand for reducing that burden. This problem can also occur when attachments other than the bucket 703 (e.g., a fork or grab) are used.

In the present example embodiment, a novel function is provided to solve such a problem. In the present example embodiment, the memory 614 of the ECU 612 stores respective set values of a first height position and a first angle respectively indicating target height positions and target angles of the attachment when the work vehicle 200 moves forward, and respective set values of a second height position and a second angle respectively indicating target height positions and target angles of the attachment when the work vehicle 200 moves in reverse. The ECU 612 executes first control to change the height position and angle of the attachment to the first height position and the first angle, respectively, in response to a first user operation that causes the work vehicle 200 to move forward. The ECU 612 further executes second control to change the height position and angle of the attachment to the second height position and the second angle, respectively, in response to a second user operation that causes the work vehicle 200 to move in reverse.

With the above operation, simply by performing an operation to move the work vehicle 200 forward, the height position and angle of the attachment are automatically adjusted to the pre-set first height position and first angle. Also, simply by performing an operation to move the work vehicle 200 in reverse, the height position and angle of the attachment are automatically adjusted to the pre-set second height position and second angle. This can greatly reduce the burden on the user from operating the loader 700.

When the attachment is the bucket 703, the first height position and the first angle may be set to values corresponding to, for example, the posture of the bucket 703 immediately before a “scooping” operation is performed. Specifically, the first height position and the first angle may be set to values corresponding to a posture in which the bucket 703 is at a position close to the ground and the bottom surface of the bucket 703 is parallel to the ground or slightly downward-tilted (dump angle α>0). Also, the second height position and the second angle may be set to values corresponding to the posture of the bucket 703 when a “transporting” operation is performed. Specifically, the second height position and the second angle may be set to values corresponding to a posture in which the bucket 703 is at a position higher than the first height position and is slightly upward-tilted (scoop angle β>0) so that transported material does not fall. This enables the height and angle of the bucket 703 to be adjusted to values corresponding to the posture immediately before scooping up transported material simply by moving the work vehicle 200 forward, and after transported material has entered the bucket 703, the bucket 703 can be scooped up simply by moving the work vehicle 200 in reverse. Since the user does not need to perform operations to adjust the height and angle of the bucket 703, the burden of work is greatly reduced. This enables high-precision work to be achieved regardless of the skill level of the worker.

The work vehicle 200 may further include a switch for switching between a first mode in which the first control and the second control are enabled and a second mode in which the first control and the second control are disabled. The switch may be included in the switches 801 illustrated in FIG. 1B. The switch may be provided on the operation lever 780. The ECU 612 may have a function of switching between the first mode and the second mode in response to an operation of the switch by a user. In that case, in the first mode, the ECU 612 executes the first control in response to the first user operation and executes the second control in response to the second user operation. In the second mode, the ECU 612 does not perform the first control and the second control, and adjusts the height and angle of the attachment in response to the user's operation of the operation lever 780 as before.

The vehicle ECU 612 may store in the memory 614 respective set values of a third height position and a third angle respectively indicating target height positions and target angles of the attachment for the second mode. In that case, the ECU 612 changes the height position and angle of the attachment to the third height position and the third angle, respectively, in response to an operation of the switch by a user to switch from the first mode to the second mode. The third height position and the third angle may be set, for example, to a height and angle suitable for the work vehicle 200 to travel without performing work. Specifically, the third height position and the third angle may be set, for example, to a height and angle at which the attachment does not contact the ground and most parts of the loader 700 do not enter the field of view of the cameras 270. This enables the user to set the first mode during work and the second mode during travel, and when switching from the first mode to the second mode, the height and angle of the attachment can be automatically adjusted to values that do not hinder travel.

As illustrated in FIG. 17, the work vehicle 200 includes a load sensor 750 to measure the load on the loader 700. The load sensor 750 is configured to measure the load applied to the attachment. The ECU 612 may execute the first control in response to the first user operation only when the load measured by the load sensor 750 exceeds a threshold value. Similarly, the ECU 612 may execute the second control in response to the second user operation only when the load measured by the load sensor 750 exceeds a threshold value. In other words, the ECU 612 may change the height position and angle of the attachment to the first height position and the first angle, respectively, only when the user performs a forward operation and the load exceeds the threshold value. Also, the ECU 612 may change the height position and angle of the attachment to the second height position and the second angle, respectively, only when the user performs a reverse operation and the load exceeds the threshold value. This makes it possible to avoid unnecessary operations such as the height and angle of the attachment changing automatically even though no transported material is placed on the attachment.

The ECU 612 may execute the first control in response to the first user operation only when a state in which the load exceeds the threshold value has continued for a predetermined time or more. Similarly, the ECU 612 may execute the second control in response to the second user operation only when a state in which the load exceeds the threshold value has continued for a predetermined time or more. The predetermined time may be set to, for example, approximately 2 to 3 seconds.

The loader 700 includes an actuator 720 (e.g., a hydraulic actuator) to change the height position and angle of the attachment. The ECU 612 and the microcontroller 710 (hereinafter sometimes collectively referred to as the “controller”) are configured or programmed to execute the first control and the second control described above by controlling the actuator 720.

It should be noted that instead of user operations using an operating tool such as the operation lever 780, the system may automatically perform forward and reverse operations. For example, when the work vehicle 200 is configured to automatically perform travel and work using the loader 700, the automatic driving control system of the work vehicle 200 performs forward, reverse, and steering operations. In that case, the controller may change the height position and angle of the attachment to preset height positions and angles in response to the automatic selection operation by the system.

The work vehicle 200 includes the meter panel 100 as a display that displays a setting screen for setting each of the first height position, the first angle, the second height position, and the second angle. Instead of the meter panel 100, another display such as the operation terminal 802 illustrated in FIG. 1B or a mobile terminal used by the user may be used. The user can set each of the first height position, the first angle, the second height position, and the second angle by operating an input device on the displayed setting screen.

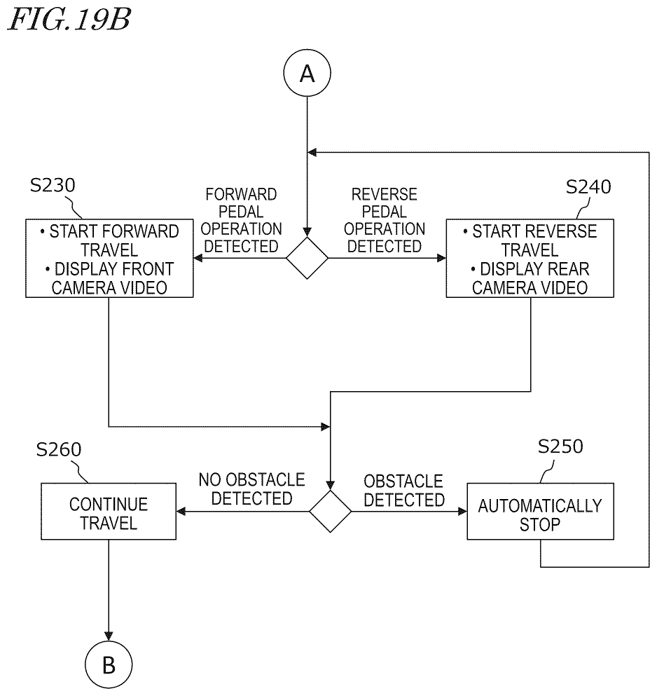

FIGS. 19A and 19B are flowcharts illustrating an example of an operation of the controller (the ECU 612 and the microcontroller 710 in the present example embodiment). In this example, as illustrated in FIG. 1C, obstacle detection is performed using two cameras 270 (a front camera and a rear camera) that acquire two images, a front image and a rear image of the work vehicle 200. Obstacle detection based on images acquired by the cameras 270 may be performed by the ECU 612, by the display MCU 440 (see FIG. 13) of the meter panel 100, or by another image processing device. Obstacle detection may also be performed by the obstacle sensors 295 or LiDAR sensors 290 other than the cameras 270. These obstacle detection functions are provided as needed, and may be omitted if unnecessary.

In step S110, the controller determines whether the current mode is work mode (first mode) or travel mode (second mode). The user can switch between work mode and travel mode by operating a mode switch provided on the operation lever 780 or another operating tool. When work mode is selected, a signal indicating work mode is sent from the mode switch to the controller. When the controller detects the signal indicating work mode, it proceeds to step S120 and activates work mode. When travel mode is selected, a signal indicating travel mode is sent from the mode switch to the controller. When the controller detects the signal indicating travel mode, it proceeds to step S200 and activates travel mode.

Next, the controller determines whether a forward or reverse operation is being performed based on a signal from the forward/reverse pedal 790. A signal output from a sensor that detects whether the transmission is in the forward or reverse state may also be used for this determination. Furthermore, the controller detects the load on the loader 700 based on a signal from the load sensor 750, and compares the load with a threshold value. The controller determines whether a predetermined time has elapsed since the load exceeded the threshold value. The predetermined time may be set to a time of, for example, 1 second or more and 5 seconds or less. In one example, the predetermined time may be set to a time of 2 seconds or more and 3 seconds or less. When a forward operation is performed and the predetermined time has elapsed since the load exceeded the threshold value, the process proceeds to step S130. When a reverse operation is performed and the predetermined time has elapsed since the load exceeded the threshold value, the process proceeds to step S140.

In step S130, the controller causes the work vehicle 200 to start moving forward. At this time, the controller adjusts the height and angle of the attachment of the loader 700 to a preset first set value (the first height position and the first angle described above). This automatically adjusts the height and angle of the attachment to values suitable for scooping up transported material such as soil and sand. At this time, the controller causes the meter panel 100 to display video acquired by the front camera.

In step S140, the controller causes the work vehicle 200 to start moving in reverse. At this time, the controller adjusts the height and angle of the attachment of the loader 700 to a preset second set value (the second height position and the second angle described above). This automatically adjusts the height and angle of the attachment to values suitable for transporting transported material such as soil and sand. At this time, the controller causes the meter panel 100 to display video acquired by the rear camera. The operation of step S140 may be executed, for example, after the operation of step S130 has been performed and the transported material can be transported by the attachment, and after the user has performed a reverse operation.

While forward or reverse operation is being performed, the controller executes processing to detect obstacles. For example, a specific obstacle (e.g., a person or vehicle) can be detected by executing a predetermined obstacle detection algorithm based on images acquired by the front camera or rear camera. The obstacle detection processing may be executed not only by the controller but also by another image processing device. When an obstacle is detected, the process proceeds to step S150, and the controller stops the operation of the work vehicle 200. After the operation is stopped, operation is resumed by manual operation by the user. When no obstacle is detected, the process proceeds to step S160, and travel is continued. Thereafter, when work is completed or the work vehicle 200 arrives at the destination, the process returns to step S110, and the mode selection operation is executed again.

When the controller detects a signal indicating that the current mode is travel mode, it proceeds to step S200. In step S200, the controller activates travel mode and adjusts the height and angle of the loader attachment to the third set value (the third height position and the third angle described above). This automatically adjusts the height and angle of the attachment to values suitable for normal travel.

In travel mode, the controller determines whether a forward or reverse operation is being performed based on a signal from the forward/reverse pedal 790, as illustrated in FIG. 19B. When a forward operation is detected, the process proceeds to step S230. When a reverse operation is detected, the process proceeds to step S240. It should be noted that when neither operation is performed, the work vehicle 200 remains stopped.

In step S230, the controller causes the work vehicle 200 to start moving forward. At this time, the controller causes the meter panel 100 to display video acquired by the front camera.

In step S240, the controller causes the work vehicle 200 to start moving in reverse. At this time, the controller causes the meter panel 100 to display video acquired by the rear camera.

Even in travel mode, the controller executes obstacle detection processing based on video from the front camera or rear camera. When an obstacle is detected, the process proceeds to step S250, and the controller stops the operation of the work vehicle 200. After the operation is stopped, operation is resumed by manual operation by the user. When no obstacle is detected, the process proceeds to step S260, and travel is continued. After step S260, the process proceeds to step S170.

It should be noted that while the operations illustrated in FIGS. 19A and 19B are being executed, the user can also manually adjust the height and angle of the loader attachment by operating the operation lever 780. After the automatic adjustment in steps S130, S140, and S200 is performed, if the user wants to fine-tune the height and angle of the attachment, the desired height and angle can be adjusted by operating the operation lever 780.

In the example illustrated in FIGS. 19A and 19B, the display of video acquired by the front camera and the rear camera, and obstacle detection processing based on those videos, are performed. This display function and obstacle detection function do not necessarily need to be installed. Also, in the example of FIG. 19A, automatic adjustment of the loader is performed when a forward or reverse operation is performed and the load of the loader continues to exceed the threshold value for a predetermined time or more, but the determination based on the load of the loader may be omitted. The determination based on the load of the loader may be performed only for one of the forward and reverse directions. For example, when moving forward, the automatic adjustment of the loader height and angle may be performed immediately in response to the forward operation, and when moving in reverse, the automatic adjustment of the loader height and angle may be performed when the load is detected for a predetermined time or more in addition to the reverse operation.

With the operation of the present example embodiment, the user can switch between work mode and travel mode. In work mode, simply performing a forward operation enables the height and angle of the loader attachment to be automatically adjusted to the preset first height position and first angle. Also, in work mode, simply performing a reverse operation enables the height and angle of the loader attachment to be automatically adjusted to the preset second height position and second angle. Furthermore, simply performing an operation to switch to travel mode enables the height and angle of the loader attachment to be automatically adjusted to the preset third height position and third angle. Such automatic adjustment functions reduce the burden of work, enabling even workers with low skill levels to easily perform transportation and other tasks.

Next, an example of a setting screen for setting the first height position, the first angle, the second height position, the second angle, the third height position, and the third angle will be described. In the following description, these values are referred to as “target values”.

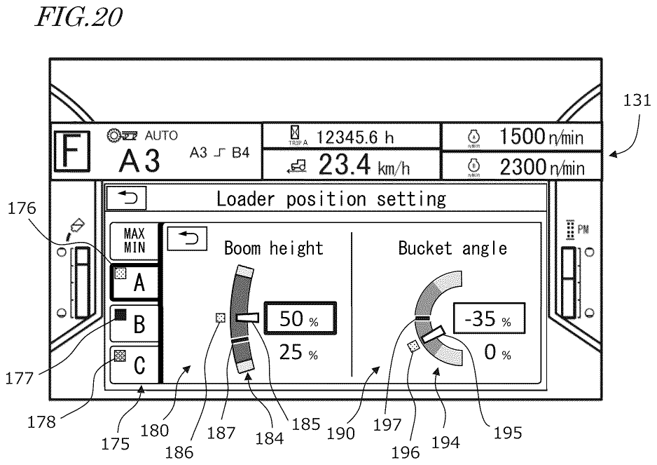

FIG. 20 is a diagram illustrating an example of a graphical user interface (GUI) on a setting screen displayed on the display 13 (digital display) of the meter panel 100. FIG. 20 illustrates an example of a setting screen for setting three target values of height and angle of the attachment of the loader 700.

The display screen illustrated in FIG. 20 is displayed when the user performs a predetermined operation using the input device 170 on the home screen (see FIG. 15) displayed after startup of the meter panel 100. This setting screen is displayed below the primary region 131 that displays information such as gear stage and vehicle speed. The setting screen illustrated in FIG. 20 includes a region 175 for selecting which of the three sets of height and angle target values to set, a region 180 for setting a target value for the height of the attachment (Boom height), and a region 190 for setting a target value for the angle of the attachment (Bucket angle). The region 175 includes three selectable regions distinguished by the letters A, B, and C. Region A is associated with the first height position and the first angle, and includes a mark 176 in a first color (e.g., yellow). Region B is associated with the second height position and the second angle, and includes a mark 177 in a second color (e.g., blue). Region C is associated with the third height position and the third angle, and includes a mark 178 in a third color (e.g., orange). The user can set the target values of height and angle corresponding to the selected region by operating the input device 170 to select one of regions A, B, and C. FIG. 20 shows, as an example, a state in which region A is selected.

The region 180 includes an arc-shaped gauge 184 for setting the target value of the height of the attachment. In the arc-shaped gauge 184, the range from the lower limit to the upper limit of the height of the attachment is expressed in a dark color. This range is a range separately set by the user. Among the maximum range of attachment height corresponding to the range of motion of the boom, the set range is expressed in a dark color. In this example, the target value of the height is indicated by a mark 185 displayed on the arc-shaped gauge 184 and the numerical value “50%”. The user can change the numerical value of the height by operating the input device 170. In response to that operation, the mark 185 moves up and down along the arc-shaped gauge 184. In this example, changes in the height of the attachment are expressed by the arc-shaped gauge 184. This makes it easier for the user to grasp the position of the attachment because the movement of the mark 185 matches the actual movement of the attachment. To the left of the gauge 184, a mark 186 indicating which of A, B, and C target height positions is currently being set is displayed. This mark 186 is displayed in the same color as the mark 176. The mark 187 on the arc-shaped gauge 184 indicates the current value of the height of the attachment.

The region 190 includes an arc-shaped gauge 194 for setting the target value of the angle of the attachment. In the arc-shaped gauge 194, the range from the lower limit to the upper limit of the angle of the attachment is expressed in a dark color. This range is a range of angle separately set by the user. Among the range of motion of the angle of the attachment, the set range of angle is expressed in a dark color. In this example, the target value of the angle is indicated by a mark 195 displayed on the arc-shaped gauge 194 and the numerical value “−70%”. The user can change the numerical value of the angle by operating the input device 170. In response to that operation, the mark 195 moves up and down along the arc-shaped gauge 194. To the left of the gauge 194, a mark 196 indicating which of A, B, and C target angles is currently being set is displayed. This mark 196 is displayed in the same color as the marks 176 and 186. The mark 197 on the arc-shaped gauge 194 indicates the current value of the angle.

When the user selects region B or C in the region 175, a setting screen with a similar layout is displayed, and another set of height and angle can be set. The sets of target values for regions A, B, and C correspond respectively to the first set value in step S130, the second set value in step S140, and the third set value in step S200 illustrated in FIG. 19A.

With such a setting screen, the user can set three sets of target height positions and target angles. After the settings are completed, the operations illustrated in FIGS. 19A and 19B become executable.

It should be noted that in the above example, three sets of target height positions and target angles are set, but only two sets (e.g., the first set value referenced in step S130 and the second set value referenced in step S140) may be settable. Also, when an attachment that does not require angle adjustment, such as a fork, is attached to the loader 700, the target angle may be set to 0% for any set. Alternatively, for a setting screen corresponding to such an attachment, a GUI may be adopted that disables the setting of target angles themselves and only allows the setting of two or three sets of target height positions.

It should be noted that the flowcharts illustrated in FIGS. 19A and 19B and the layout of the GUI illustrated in FIG. 20, etc., are merely examples and can be appropriately modified. For example, user operations are not limited to the operation lever 780 and pedal 790 described above, and may be performed by various operating tools. The operating tools may include at least one of a lever, a switch, a switch to operate a display to display a setting screen for user operation, or a displayed switch on a display (e.g., a displayed switch on a touch screen).

In the examples described above, various display screens are displayed on the display 13 of the meter panel 100, but the present disclosure is not limited thereto. The display screens may also be displayed on the display of, for example, the operation terminal 802 such as the virtual terminal (VT) illustrated in FIG. 1B, or a mobile terminal used by the user. In this way, a VT or a mobile terminal used by the user may also be included in the information display system.

The information display systems or control systems in the above example embodiments can also be retrofitted to work vehicles that do not have these functions. Such systems may be manufactured and sold independently of work vehicles. Computer programs used in such systems may also be manufactured and sold independently of work vehicles. Computer programs may be provided, for example, stored on computer-readable non-transitory storage media. Computer programs may also be provided by download via telecommunication lines (e.g., the Internet).

The technologies and example embodiments of the present disclosure are widely applicable to various types of work vehicles used in, for example, smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A work vehicle comprising:
a loader capable of changing a height position and an angle of an attachment at a tip thereof; and
a controller configured or programmed to:
control an operation of the loader;
include a memory configured to store respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse; and
execute first control to change the height position and angle of the attachment to the first height position and the first angle, respectively, in response to a first user operation that causes the work vehicle to move forward; and
execute second control to change the height position and angle of the attachment to the second height position and the second angle, respectively, in response to a second user operation that causes the work vehicle to move in reverse.

2. The work vehicle of claim 1, further comprising a switch configured to switch between a first mode in which the first control and the second control are enabled and a second mode in which the first control and the second control are disabled; wherein
the controller is configured or programmed to:
switch between the first mode and the second mode in response to an operation of the switch by a user; and
in the first mode, execute the first control in response to the first user operation and execute the second control in response to the second user operation.

3. The work vehicle of claim 2, wherein the memory is configured to store respective set values of a third height position and a third angle respectively indicating target height positions and target angles of the attachment for the second mode; and
the controller is configured or programmed to change the height position and angle of the attachment to the third height position and the third angle, respectively, in response to an operation of the switch by a user to switch from the first mode to the second mode.

4. The work vehicle of claim 1, further comprising a sensor to measure a load on the loader; wherein
the controller is configured or programmed to execute the first control in response to the first user operation and execute the second control in response to the second user operation only when the load exceeds a threshold value.

5. The work vehicle of claim 4, wherein the controller is configured or programmed to execute the first control in response to the first user operation and execute the second control in response to the second user operation only when a state in which the load exceeds the threshold value has continued for a predetermined time or more.

6. The work vehicle of claim 1, further comprising a display configured to display a setting screen for setting each of the first height position, the first angle, the second height position, and the second angle.

7. The work vehicle of claim 6, wherein the display includes a meter panel including a digital display to display the setting screen and one or more analog meters.

8. The work vehicle of claim 1, wherein
the loader includes an actuator configured to change the height position and angle of the attachment; and
the controller is configured or programmed to execute the first control and the second control by controlling the actuator.

9. A controller for controlling a loader in a work vehicle to which a loader capable of changing a height position and an angle of an attachment at a tip thereof is attached, the controller comprising:
a memory configured to store respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse; and
a control circuit configured to execute first control to change the height position and angle of the attachment to the first height position and the first angle, respectively, in response to a first user operation that causes the work vehicle to move forward, and execute second control to change the height position and angle of the attachment to the second height position and the second angle, respectively, in response to a second user operation that causes the work vehicle to move in reverse.

10. A method for controlling a loader executed by a controller in a work vehicle to which a loader capable of changing a height position and an angle of an attachment at a tip thereof is attached, the method comprising:
storing in a memory respective set values of a first height position and a first angle respectively indicating target height positions and target angles of the attachment when the work vehicle moves forward, and respective set values of a second height position and a second angle respectively indicating target height positions and target angles of the attachment when the work vehicle moves in reverse;
executing first control to change the height position and angle of the attachment to the first height position and the first angle, respectively, in response to a first user operation that causes the work vehicle to move forward; and
executing second control to change the height position and angle of the attachment to the second height position and the second angle, respectively, in response to a second user operation that causes the work vehicle to move in reverse.
